(19) United States
(12) Patent Application Publication
(10) Pub. No.: US 2008/0150725 A1
(43) Pub. Date: Jun. 26, 2008

(54) RFID LABEL TAG AND METHOD OF MANUFACTURING THE SAME

(76) Inventor: Nobuaki TAKAHASHI, Tokyo (JP)

Correspondence Address: MILES & STOCKBRIDGE PC, 1751 PINNACLE DRIVE, SUITE 500, MCLEAN, VA, 22102-3833, US

(21) Appl. No.: 11/853,806

(22) Filed: Sep. 11, 2007

(30) Foreign Application Priority Data
Sep. 29, 2006 (JP) 2006-269681

(51) Int. Cl. G08B 13/14; H01Q 17/00

(52) U.S. Cl. 340/572.7; 29/601

(57) ABSTRACT

To provide a contactless electronic tag having mass productivity and a structure that has extended a communication range and a directionality of communication. In the structure, a wave director and a reflector having a planar pattern in the shape of an approximate L letter and formed in the same dimensioned planar pattern are pasted to an adhesive surface of a label seal in a point symmetric manner via an inlet 1 in between on the adhesive surface of the label seal so that the wave director and the reflector are arranged in close proximate to and along the periphery of the label seal. Due to this, it becomes possible to improve the mass productivity of the contactless electronic tag and efficiently receive radio waves radiated from an antenna of a reader while reducing a circular polarization loss.

### BACKGROUND OF THE INVENTION

The present invention relates to an RFID label tag and, more particularly, to a technique effective when applied to a contactless electronic tag comprising an auxiliary antenna.

In Japanese patent laid-open No. 2005-198168 (Patent document 1), a technique is disclosed, which improves a write rate and read rate of information of a label using a contactless information recording medium by forming the label by pasting an antenna section with an IC chip mounted on a dielectric substrate and an electric conductor separated from the antenna section to each other.

### SUMMARY OF THE INVENTION

A contactless electronic tag is a tag in which desired data is stored in a memory circuit in a semiconductor chip and the data is read out using microwave, and which has a structure mounting a semiconductor chip on an antenna composed of a lead frame.

Since data is stored in the memory circuit of the semiconductor chip, the electronic tag has an advantage over a tag utilizing a barcode in that data of larger capacity can be stored. In addition, there is other advantage for the data stored in the memory circuit in that unauthorized alteration is more difficult compared to the data stored in the barcode.

The inventors of the present invention are now examining a technique capable of extending the communication range of a contactless electronic tag and further extending the communication directionality, and the key challenge is to reduce production cost by automating the manufacturing process of electronic tags as well as to improve the communication performance of these contactless electronic tags.

An object of the present invention is to provide a contactless electronic tag with a structure providing high mass-productivity and extending the communication range and the communication directionality.

The above-mentioned object and other objects, and novel characteristics of the present invention will become apparent from the description of the present specification and accompanied drawings.

Among the inventions to be disclosed in the present application, the outline of typical ones will be briefly described as follows.

An RFID label tag comprising an insulating tag substrate having a first main surface and a second main surface on the opposite side of the first main surface, and having, on the first main surface of the tag substrate, a semiconductor chip having a communication means that performs data communication by radio waves transmitted from an external communication device and a storage means that stores data, a conductive antenna section connected to the semiconductor chip, and a conductive auxiliary antenna section provided in close proximity to the antenna, wherein the auxiliary antenna is arranged so as to be capacitively coupled to the antenna on the same plane as the antenna is placed on, via the straight line part along one side of the antenna.

Among the inventions to be disclosed in the present application, effects obtained from typical ones will be briefly described as follows.

It is possible to provide a contactless electronic tag with a structure providing high mass-productivity and extending the communication range and the communication directionality.

### BRIEF DESCRIPTION OF THE DRAWINGS

FIG. 1 is a plan view (surface side) showing an electronic tag inlet to be incorporated in a contactless electronic tag in a first embodiment of the present invention.

FIG. 2 is a plan view showing part of FIG. 1 in an enlarged view.

FIG. 3 is a side view showing the electronic tag inlet to be incorporated in the contactless electronic tag in the first embodiment of the present invention.

FIG. 4 is a plan view (backside) showing the electronic tag inlet to be incorporated in the contactless electronic tag in the first embodiment of the present invention.

FIG. 5 is a plan view showing part of FIG. 4 in an enlarged view.

FIG. 6 is an enlarged plan view (front side) of critical parts of the electronic tag inlet to be incorporated in the contactless electronic tag in the first embodiment of the present invention.

FIG. 7 is an enlarged plan view (backside) of critical parts of the electronic tag inlet to be incorporated in the contactless electronic tag in the first embodiment of the present invention.

FIG. 8 is a plan view of a semiconductor chip mounted on the electronic tag inlet to be incorporated in the contactless electronic tag in the first embodiment of the present invention.

FIG. 9 is a sectional view of a bump electrode and its vicinity formed on the main surface of the semiconductor chip shown in FIG. 8.

FIG. 10 is a sectional view of a dummy bump electrode and its vicinity formed on the main surface of the semiconductor chip shown in FIG. 8.

FIG. 11 is a block diagram of a circuit formed on the main surface of the semiconductor chip shown in FIG. 8.

FIG. 12 is a flow chart for illustrating a manufacturing process of the electronic tag inlet to be incorporated in the contactless electronic tag in the first embodiment of the present invention.

FIG. 13 is a plan view showing part of a long insulating film used in the manufacture of the electronic tag inlet to be incorporated in the contactless electronic tag in the first embodiment of the present invention.

FIG. 14 is a plan view showing part of the insulating film shown in FIG. 13 in an enlarged view.

FIG. 15 is a schematic diagram of an inner lead bonder showing part of the manufacturing process (connecting process of a semiconductor chip and an antenna) of the electronic tag inlet to be incorporated in the contactless electronic tag in the first embodiment of the present invention.

FIG. 16 is a schematic diagram showing critical parts of the inner lead bonder shown in FIG. 15 in an enlarged view.

FIG. 17 is an enlarged plan view of critical parts of the insulating film showing part of the manufacturing process (connecting process of a semiconductor chip and an antenna) of the electronic tag inlet to be incorporated in the contactless electronic tag in the first embodiment of the present invention.

FIG. 18 is an enlarged plan view of critical parts of the insulating film showing part of the manufacturing process (connecting process of the semiconductor chip and the antenna) of the electronic tag inlet to be incorporated in the contactless electronic tag in the first embodiment of the present invention.

FIG. 19 is a schematic diagram showing part of the manufacturing process (resin sealing process of a semiconductor chip) of the electronic tag inlet to be incorporated in the contactless electronic tag in the first embodiment of the present invention.

FIG. 20 is an enlarged plan view of critical parts of the insulating film showing part of the manufacturing process (resin sealing process of a semiconductor chip) of the electronic tag inlet to be incorporated in the contactless electronic tag in the first embodiment of the present invention.

FIG. 21 is a side view showing a state in which an insulating film used in the manufacture of the electronic tag inlet to be incorporated in the contactless electronic tag in the first embodiment of the present invention is wound around a reel.

FIG. 22 is a plan view showing part of a long insulating film used in the manufacture of the electronic tag inlet to be incorporated in the contactless electronic tag in the first embodiment of the present invention.

FIG. 23 is a perspective view of critical parts of a label seal used in the manufacture of the contactless electronic tag in the first embodiment of the present invention.

FIG. 24 is a side view of critical parts of the label seal used in the manufacture of the contactless electronic tag in the first embodiment of the present invention.

FIG. 25 is a plan view of critical parts of the label seal used in the manufacture of the contactless electronic tag in the first embodiment of the present invention.

FIG. 26 is a schematic diagram showing a process of pasting an inlet to the adhesive surface of the label seal used in the manufacture of the contactless electronic tag in the first embodiment of the present invention.

FIG. 27 is a schematic diagram showing the process of pasting the inlet to the adhesive surface of the label seal following FIG. 26.

FIG. 28 is a schematic diagram showing the process of pasting the inlet to the adhesive surface of the label seal following FIG. 27.

FIG. 29 is a plan view of critical parts after the label seal used in the manufacture of the contactless electronic tag in the first embodiment of the present invention is pasted to the inlet.

FIG. 30 is a schematic diagram showing a process of pasting an inlet to the adhesive surface of the label seal used in the manufacture of the contactless electronic tag in the first embodiment of the present invention.

FIG. 31 is a plan view showing a state in which an inlet, a wave director, and a reflector are pasted to the adhesive surface of the label seal used in the manufacture of the contactless electronic tag in the first embodiment of the present invention.

FIG. 32 is an equivalent circuit diagram for illustrating a matching circuit formed by arranging the wave director and reflector in the contactless electronic tag in the first embodiment of the present invention.

FIG. 33 is a plan view showing a state in which the inlet, wave director, and reflector are pasted to the adhesive surface of the label seal used in the manufacture of the contactless electronic tag in the first embodiment of the present invention.

FIG. 34 is a plan view showing a state in which the inlet, wave director, and reflector are pasted to the adhesive surface of the label seal used in the manufacture of the contactless electronic tag in the first embodiment of the present invention.

FIG. 35 is a plan view showing a state in which the inlet, wave director, and reflector are pasted to the adhesive surface of the label seal used in the manufacture of the contactless electronic tag in the first embodiment of the present invention.

FIG. 36 is a plan view showing a state in which the inlet, wave director, and reflector are pasted to the adhesive surface of the label seal used in the manufacture of the contactless electronic tag in the first embodiment of the present invention.

FIG. 37 is a plan view showing a state in which the inlet, wave director, and reflector are pasted to the adhesive surface of the label seal used in the manufacture of the contactless electronic tag in the first embodiment of the present invention.

FIG. 38 is a plan view showing a state in which the inlet, wave director, and reflector are pasted to the adhesive surface of the label seal used in the manufacture of the contactless electronic tag in the first embodiment of the present invention.

FIG. 39 is a plan view showing a state in which the inlet, wave director, and reflector are pasted to the adhesive surface of the label seal used in the manufacture of the contactless electronic tag in the first embodiment of the present invention.

FIG. 40 is a plan view of critical parts of a seal material supplying a wave director and a reflector of the contactless electronic tag in the first embodiment of the present invention.

FIG. 41 is a plan view of critical parts of the seal material supplying the wave director and reflector of the contactless electronic tag in the first embodiment of the present invention.

FIG. 42 is a sectional view of critical parts corresponding to A-A line in FIG. 40.

FIG. 43 is a sectional view of critical parts corresponding to the A-A line in FIG. 40.

FIG. 44 is a sectional view of critical parts corresponding to the A-A line in FIG. 40.

FIG. 45 is a plan view of critical parts of the seal material supplying the wave director and reflector of the contactless electronic tag in the first embodiment of the present invention.

FIG. 46 is a plan view of critical parts of the seal material supplying the wave director and reflector of the contactless electronic tag in the first embodiment of the present invention.

FIG. 47 is a top view of critical parts of a device (jig) pasting the wave director and reflector of the contactless electronic tag in the first embodiment of the present invention to the label seal.

FIG. 48 is a side view of critical parts of the device (jig) pasting the wave director and reflector of the contactless electronic tag in the first embodiment of the present invention to the label seal.

FIG. 49 is a side view of critical parts of the device (jig) pasting the wave director and reflector of the contactless electronic tag in the first embodiment of the present invention to the label seal.

FIG. 50 is a plan view showing a state in which an inlet, a wave director, and a reflector are pasted to the adhesive surface of a label seal used in the manufacture of a contactless electronic tag in a second embodiment of the present invention.

FIG. 51 is a plan view showing a state in which the inlet, wave director, and reflector are pasted to the adhesive surface of the label seal used in the manufacture of the contactless electronic tag in the second embodiment of the present invention.

FIG. 52 is a plan view showing a state in which the inlet, wave director, and reflector are pasted to the adhesive surface of the label seal used in the manufacture of the contactless electronic tag in the second embodiment of the present invention.

FIG. 53 is a plan view showing a state in which the inlet, wave director, and reflector are pasted to the adhesive surface of the label seal used in the manufacture of the contactless electronic tag in the second embodiment of the present invention.

FIG. 54 is a plan view showing a state in which the inlet, wave director, and reflector are pasted to the adhesive surface of the label seal used in the manufacture of the contactless electronic tag in the second embodiment of the present invention.

FIG. 55 is a plan view showing a state in which the inlet, wave director, and reflector are pasted to the adhesive surface of the label seal used in the manufacture of the contactless electronic tag in the second embodiment of the present invention.

FIG. 56 is a plan view showing a state in which an inlet, a wave director, and a reflector are pasted to the adhesive surface of a label seal used in the manufacture of the contactless electronic tag in a third embodiment of the present invention.

FIG. 57 is a plan view showing a state in which the inlet, wave director, and reflector are pasted to the adhesive surface of the label seal used in the manufacture of the contactless electronic tag in the third embodiment of the present invention.

FIG. 58 is a plan view showing a state in which the inlet, wave director, and reflector are pasted to the adhesive surface of the label seal used in the manufacture of the contactless electronic tag in the third embodiment of the present invention.

FIG. 59 is a plan view showing a state in which the inlet, wave director, and reflector are pasted to the adhesive surface of the label seal used in the manufacture of the contactless electronic tag in the third embodiment of the present invention.

FIG. 60 is a plan view showing a state in which the inlet, wave director, and reflector are pasted to the adhesive surface of the label seal used in the manufacture of the contactless electronic tag in the third embodiment of the present invention.

FIG. 61 is a plan view showing a state in which the inlet, wave director, and reflector are pasted to the adhesive surface of the label seal used in the manufacture of the contactless electronic tag in the third embodiment of the present invention.

FIG. 62 is a plan view showing part of a long insulating film used in the manufacture of an electronic tag inlet, a wave director, and a reflector to be incorporated in the contactless electronic tag in the third embodiment of the present invention.

FIG. 63 is a plan view showing a state in which the inlet, wave director, and reflector are pasted to the adhesive surface of the label seal used in the manufacture of the contactless electronic tag in the present invention.

FIG. 64 is a plan view showing a state in which the inlet, wave director, and reflector are pasted to the adhesive surface of the label seal used in the manufacture of the contactless electronic tag in the present invention.

### DETAILED DESCRIPTION OF THE PREFERRED EMBODIMENTS

Before the present invention of the present application is described in detail, the meanings of terms in the present application will be described as follows.

An electronic tag is a main electronic part in an RFID (Radio Frequency IDentification) system and an EPC (Electronic Product Code) system and refers to a chip of a size of several millimeters or less in general (larger chips are also included) having electronic information, a communication function, and a data rewrite function, and communicates with a reader by radio waves or electromagnetic waves. It is referred also as a radio tag or an IC tag and by attaching it to commercial goods, it is possible to realize more sophisticated and complicated information processing than processing using a barcode. There also exists a tag that does not have a battery and can be used almost permanently by receiving power from the antenna side (outside or inside of the chip) by means of the technique of contactless power transmission. Tags include various types of shapes, such as a label type, card type, coin type, and stick type, and a proper type is selected in accordance with its use. The communication range reaches from several millimeters to several meters, and proper ranges are used for different purposes.

An inlet (in general, a compound of an RFID chip and an antenna, however, one without antenna or one in which an antenna is integrated on a chip is also included. Consequently, an inlet without antenna is sometimes included as an inlet) refers to a basic form of a product in a state in which an IC chip is mounted on a metal coil (antenna), and therefore, the metal coil and the IC chip are in a state of being exposed to the outside in general, however, in some cases, they may be sealed.

Proximate junction refers to a state in which plural electronic parts are brought into electrical coupling without being connected directly, that is, coupled in terms of electric circuitry, for example, by coupling via a capacitor etc. and electrically coupled by a high frequency operation of the circuit.

When necessary for convenience, the following embodiments will be described by dividing them into plural sections or into individual embodiments, however, except when specified explicitly, they are not independent of one another but in such a relationship that one is an example of modification of a part or the whole of the other, a detailed explanation, a supplementary explanation, etc.

In addition, when the number of elements etc. (the number of units, numerical values, quantity, range, etc., are included) is referred to in the following embodiments, the number is not limited to the specific number but may be a number equal to or greater or less than the specific number, except when specified explicitly or when the number is obviously limited to a specific number in principle.

Further, in the following embodiments, it is needless to say that components (elementary steps etc. are also included) are not always indispensable except when specified explicitly or when they can be thought obviously to be indispensable in principle. In addition, it is also needless to say that, regarding the components etc. in the embodiments, the wording “comprising A” or “including A” does not mean that components other than A are excluded except when specified explicitly that only the component is involved.

Similarly, in the following embodiments, when the shape of the components, the positional relationship, etc., are referred to, those having similar to or substantially the same shape etc. as the components shall be included except when specified explicitly or when it is obviously not the case in principle. This also applies to the above-mentioned numerical values and ranges.

In addition, when materials etc. are referred to, a specified material is a main material and secondary elements, additives, additional elements are not excluded except when specified explicitly or when it is not the case in principal or in circumstances. For example, a silicon material shall include added impurities, binary or ternary alloys etc. with silicon as a main element (for example, SiGe), etc., in addition to pure silicon except when specified explicitly.

In addition, when the present embodiments are to be described, those having the same function are assigned the same symbol in all of the drawings and their duplicated description is omitted.

In addition, in the drawings used in the present embodiments, there are some cases where even a plan view may be partially hatched for making it easy-to-see.

The present embodiments will be described below in detail based on the drawings.

### First Embodiment

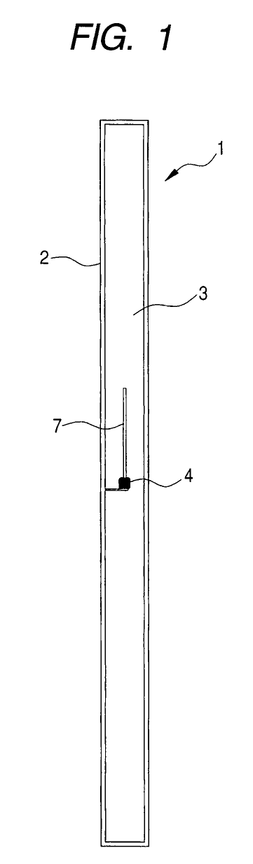

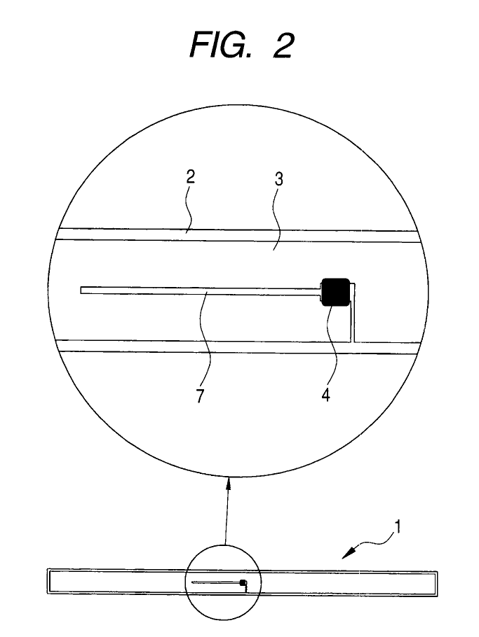

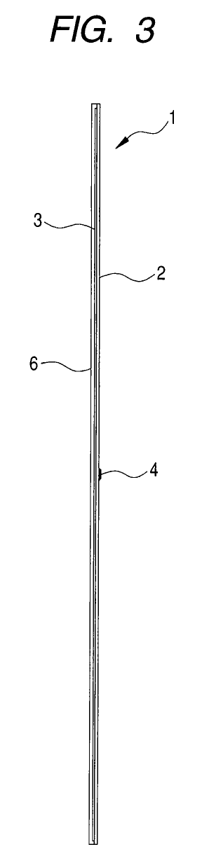

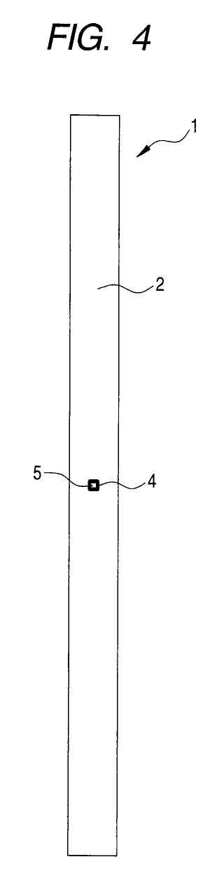

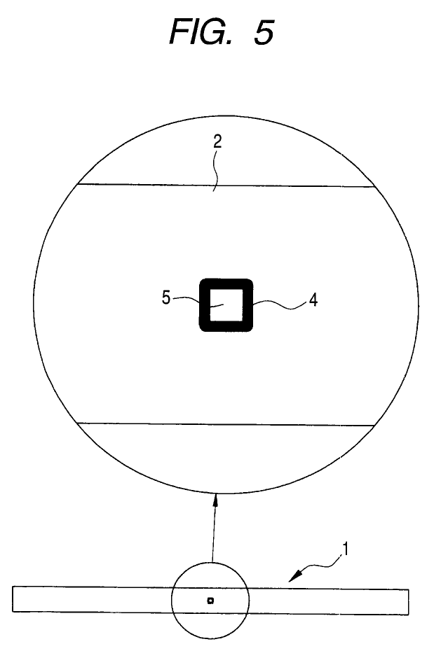

FIG. 1 is a plan view (surface side) showing an inlet for contactless electronic tag in a first embodiment of the present invention, FIG. 2 is a plan view showing part of FIG. 1 in an enlarged view, FIG. 3 is a side view showing the inlet for contactless electronic tag in the present first embodiment, FIG. 4 is a plan view (backside) of the inlet for contactless electronic tag in the present first embodiment, and FIG. 5 is a plan view showing part of FIG. 4 in an enlarged view. As described above, the part or the whole of the present embodiment (example) is a part or whole of subsequent embodiments (examples). Consequently, description of duplicated part is omitted as a general rule.

An inlet for contactless electronic tag (hereinafter, referred to simply as an inlet) 1 in the first embodiment of the present invention constitutes the main part of a contactless electronic tag comprising an antenna for receiving microwaves. The inlet 1 comprises an antenna (antenna section) 3 composed of an Al foil (first conductive film) pasted to one surface of an elongated rectangular insulating film 2 and a chip 5 connected to the antenna 3 in a state in which its surface and side are sealed with a potting resin 4. One surface (surface on which the antenna 3 is formed) of the insulating film 2 is laminated as needed with a cover film 6 in order to protect the antenna 3 or the chip 5.

The length of the antenna 3 along the direction of the long side of the above-mentioned insulating film 2 is, for example, 56 mm and is optimized so as to be capable of efficiently receiving microwaves having a frequency of 2.45 GHz. In addition, the width of the antenna 3 is 3 mm and is optimized so as to be capable of both reducing the inlet 1 in size and ensuring its strength.

Substantially in the center of the antenna 3, an “L”-shaped slit 7 one end of which reaches the periphery of the antenna 3 is formed, and in the midway of the slit 7, the chip 5 sealed with the potting resin 4 is mounted.

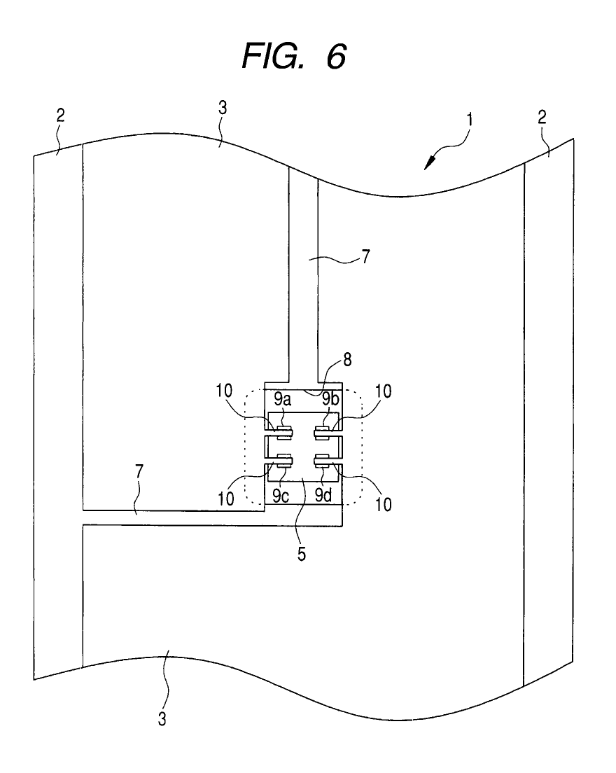

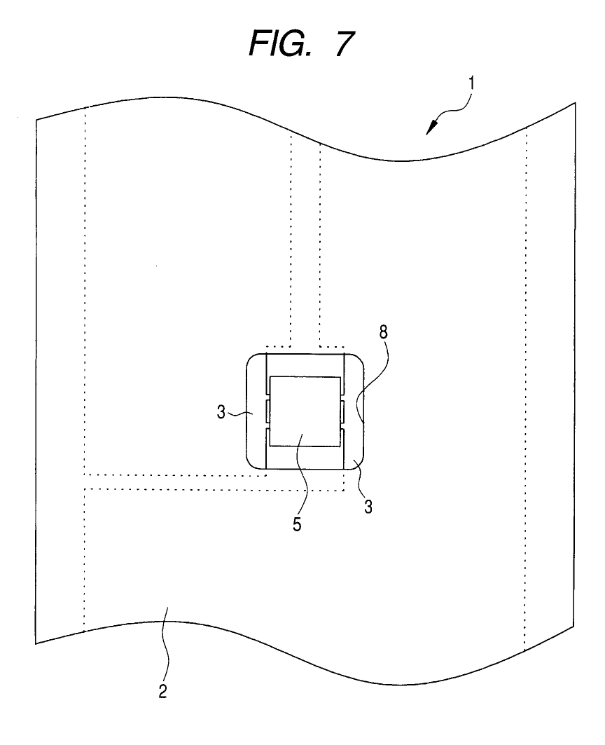

FIG. 6 and FIG. 7 are plan views showing the center part and its vicinity of the antenna 3 on which the above-mentioned slit 7 is formed in an enlarged view, wherein FIG. 6 shows the surface side of the inlet 1 and FIG. 7 shows the backside thereof. In these figures, the potting resin 4 that seals the chip 5 and the cover film 6 are not shown.

As shown schematically, in the midway of the slit 7, a device hole is formed by punching out part of the insulating film 2 and the above-mentioned chip 5 is placed in the center of the device hole 8. The dimensions of the device hole 8 are, for example, length×width=0.8 mm×0.8 mm and the dimensions of the chip 5 are length×width=0.48 mm×0.48 mm.

As shown in FIG. 6, on the main surface of the chip 5, four Au (gold) bumps 9a, 9b, 9c, and 9d are formed. The respective Au bumps 9a, 9b, 9c, and 9d are connected to leads 10 formed integrally with the antenna 3 and one end of which extends into the inside of the device hole 8.

Among the above-mentioned four leads 10, two of the leads 10 extend from one side of the antenna 3 divided into two parts by the slit 7 into the inside of the device hole 8 and are connected electrically with the Au bumps 9a, 9c of the chip 5. The remaining two leads 10 extend from the other side of the antenna 3 into the inside of the device hole 8 and are connected electrically with the Au bumps 9b, 9d of the chip 5.

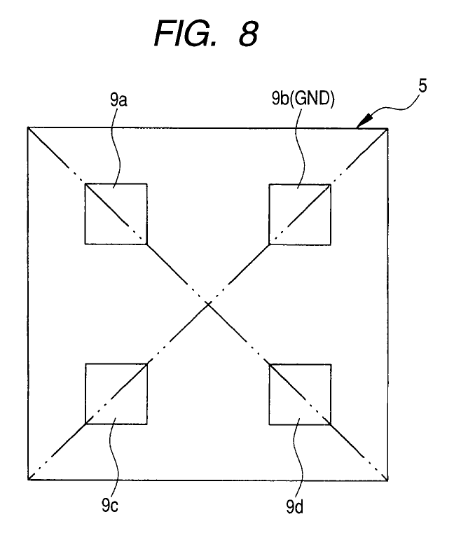

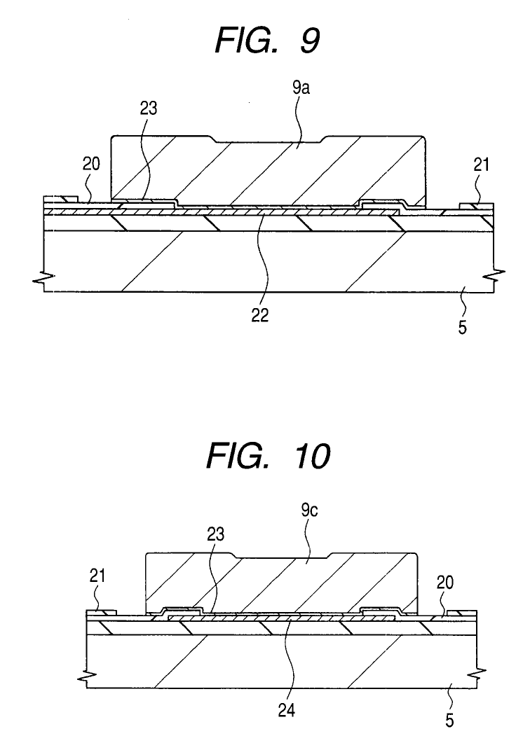

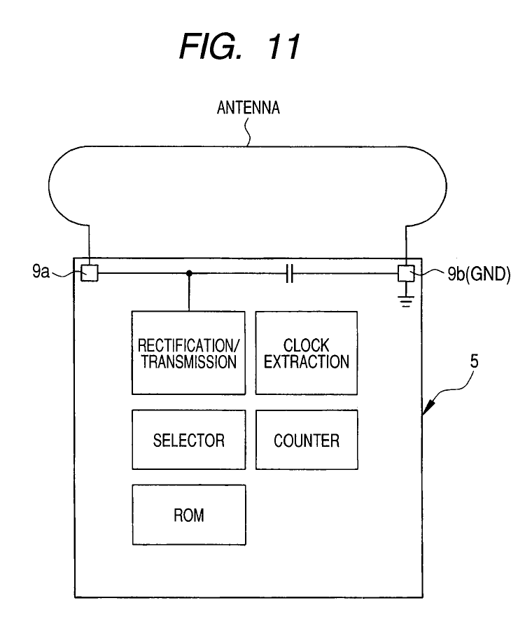

FIG. 8 is a plan view showing the layout of the four Au bumps 9a, 9b, 9c, and 9d formed on the main surface of the above-mentioned chip 5, FIG. 9 is an enlarged sectional view of the vicinity of the Au bump 9a, FIG. 10 is an enlarged sectional view of the vicinity of the Au bump 9c, and FIG. 11 is a block diagram of a circuit formed on the chip 5.

The chip 5 is composed of a single crystal silicon substrate having a thickness of about 0.15 mm and on its main surface, a circuit composed of rectification/transmission (communication means), clock extraction, a selector, a counter, ROM (or RAM (storage means)), etc., as shown in FIG. 11 is formed. The ROM has a storage capacity of 128 bits and is capable of storing data of larger capacity compared to that of a storage medium such as a barcode. Further, the data stored in the ROM has an advantage that unauthorized alteration is more difficult compared to the data stored in the barcode.

On the main surface of the chip 5 on which the above-mentioned circuit is formed, the four Au bumps 9a, 9b, 9c, and 9d are formed. These four Au bumps 9a, 9b, 9c, and 9d are positioned on a pair of virtual diagonals shown by the alternate long and two dashes lines in FIG. 8 and are laid out substantially equidistantly from the intersection (the center of the main surface of the chip 5) of these diagonals. These Au bumps 9a, 9b, 9c, and 9d are formed by using, for example, the electrolytic plating method, and their height is, for example, about 15 μm.

Although the layout of these Au bumps 9a, 9b, 9c, and 9d is not limited to the layout shown in FIG. 8., it is preferable to layout the bumps so as to easily maintain balance when weight is applied at the time of bonding chips. For example, it is preferable to arrange the Au bumps so that a polygon formed by the tangents of the Au bumps surrounds the center of the chip in the plane layout.

Among the above-mentioned four Au bumps 9a, 9b, 9c, and 9d, for example, the Au bump 9a constitutes an input terminal of the circuit shown in the above-mentioned FIG. 11 and the Au bump 9b constitutes a GND terminal. The remaining two Au bumps 9c, 9d constitute dummy bumps not connected to the above-mentioned circuit.

As shown in FIG. 9, the Au bump 9a constituting the input terminal of the circuit is formed on an uppermost layer metal wire 22 exposed by etching a passivation film 20 and a polyimide resin 21 that cover the main surface of the chip 5. Further, between the Au bump 9a and the uppermost layer metal wire 22, a barrier metal film 23 is formed to enhance adhesion between both. The passivation film 20 includes, for example, a film stack of an oxide silicon film and a nitride silicon film, and the uppermost layer metal wire 22 includes, for example, an Al alloy film. The barrier metal film 23 includes, for example, a film stack of a Ti film having a high adhesion to the Al alloy film and a Pd film having a high adhesion to the Au bump 9a. Although not shown schematically, the connection part of the Au bump 9b constituting the GND terminal of the circuit and the uppermost layer metal wire 22 also has the same configuration as that described above. On the other hand, as shown in FIG. 10, the Au bump 9c (and 9d) constituting the dummy bump is connected to a metal layer 24 formed in the same wiring layer as the above-mentioned uppermost layer metal wire 22, however, the metal layer 24 is not connected to the above-mentioned circuit.

As described above, in the inlet 1 in the present first embodiment, the slit 7 one end of which reaches the periphery of the antenna 3 is provided in part of the antenna 3 formed on one surface of the insulating film 2, and the input terminal (Au bump 9a) of the chip 5 is connected to one side of the antenna 3 divided into two parts by the slit 7, and the GND terminal (Au bump 9b) of the chip 5 is connected to the other. With such a configuration, the effective length of the antenna 3 can be lengthened, and therefore, it is possible to reduce the inlet 1 in size while ensuring the required length of the antenna.

In addition, in the inlet 1 in the present first embodiment, the Au bumps 9a, 9b constituting the terminals of the circuit and the dummy Au bumps 9c, 9d are provided on the main surface of the chip 5, and these four Au bumps 9a, 9b, 9c, and 9d are connected to the leads 10 of the antenna 3. With such a configuration, compared to the case where only the two Au bumps 9a, 9b connected to the circuit are connected to the leads 10, the effective contact area between the Au bumps and the lead 10 becomes larger, and therefore, the adhesion strength between the Au bumps and the lead 10, that is, the reliability of connection of both is improved. In addition, by arranging the four Au bumps 9a, 9b, 9c, and 9d on the main surface of the chip 5 in the layout as shown in FIG. 8, it is unlikely that the chip 5 is inclined with respect to the insulating film 2 when the leads 10 are bonded to the Au bumps 9a, 9b, 9c, and 9d. Due to this, it is possible to securely seal the chip 5 with the potting resin 4 and thus the yield of production of the inlet 1 improves.

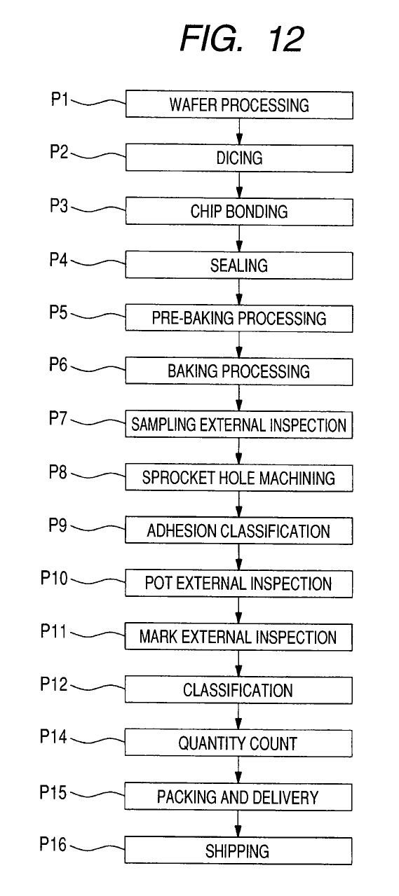

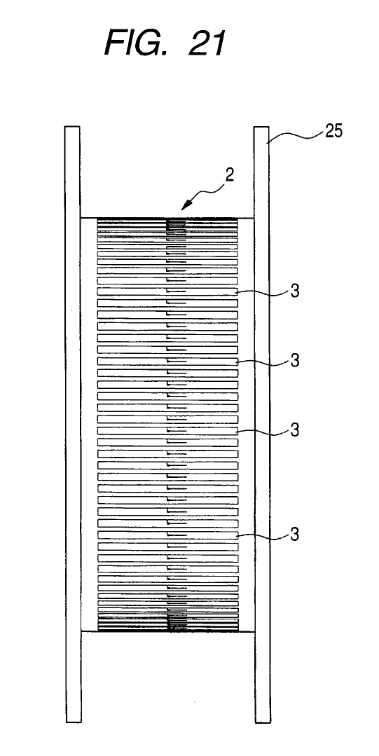

Next, a method for manufacturing the inlet 1 configured as described above will be described using FIG. 12 to FIG. 21. FIG. 12 is a flow chart for illustrating a manufacturing process of the inlet 1.

First, wafer processing is executed, in which a semiconductor elements, an integrated circuit, and the above-mentioned bump electrodes 9a, 9b, 9c, 9d, etc., are formed on the main surface of a wafer-like semiconductor substrate (hereinafter, referred to simply as a substrate) (process P1). Subsequently, the wafer-like substrate is divided into units of chips by dicing and the above-described chips 5 are formed (process P2).

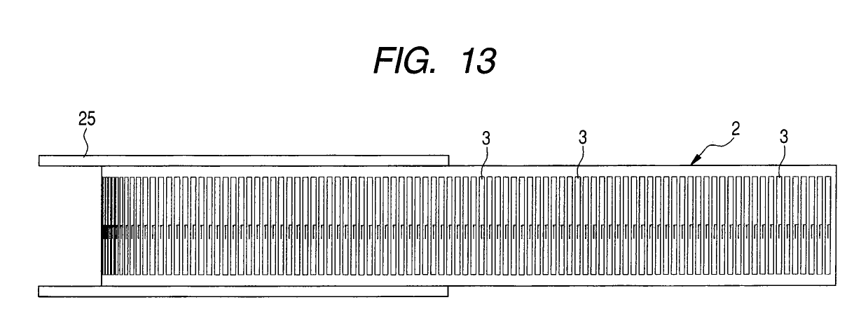

FIG. 13 is a plan view showing the insulating film 2 used for manufacture of the inlet 1 and FIG. 14 is a plan view showing part of FIG. 13 in an enlarged view.

As shown in FIG. 13, the insulating film 2 in the form of a continuous tape is put into the manufacturing process of the inlet 1 in a state of being wound around a reel 25. On one surface of the insulating film 2, a large number of antennas 3 are formed in advance at predetermined intervals. In order to form these antennas 3, for example, an Al foil having a thickness of about 20 μm is pasted to one surface of the insulating film 2 and the Al foil is etched into the shape of the antenna 3. At this time, on the respective antennas 3, the slit 7 and the lead 10 described above are formed. The insulating film 2 is in conformity to the standard of the film carrier tape and composed of, for example, a film made of polyethylene naphthalate having a width of 50 mm or 70 mm and a thickness of 25 μm. As described above, by forming the antenna 3 from the Al foil and forming the insulating film 2 from the polyethylene naphthalate, it is possible to reduce the material cost of the inlet 1 compared to the case where, for example, the antenna 3 is formed from a Cu foil and the insulating film 2 is made of a polyimide resin.

Then, an identification mark for identifying the kind of product, such as a product No. of the inlet 1 etc., is given to the surface on which the chip 5 of the antenna 3 is mounted. It is possible to form this identification mark by, for example, a marking method using laser etc.

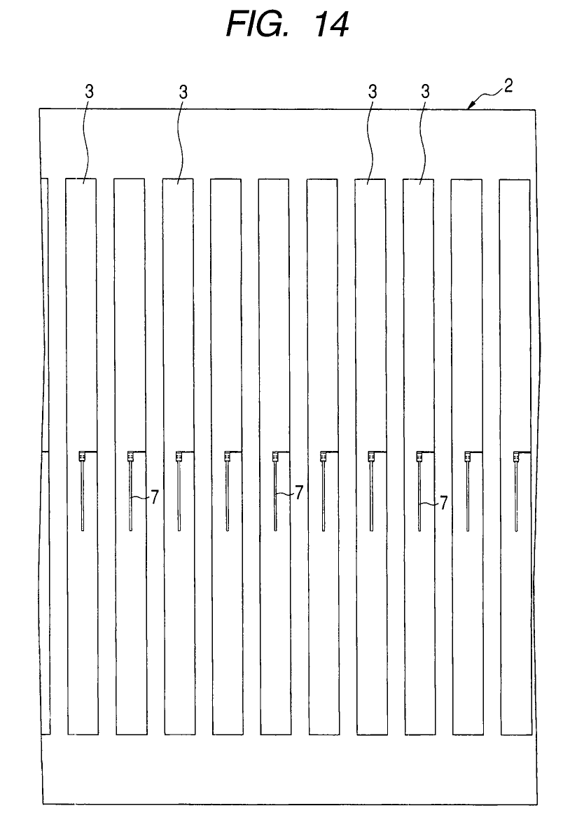

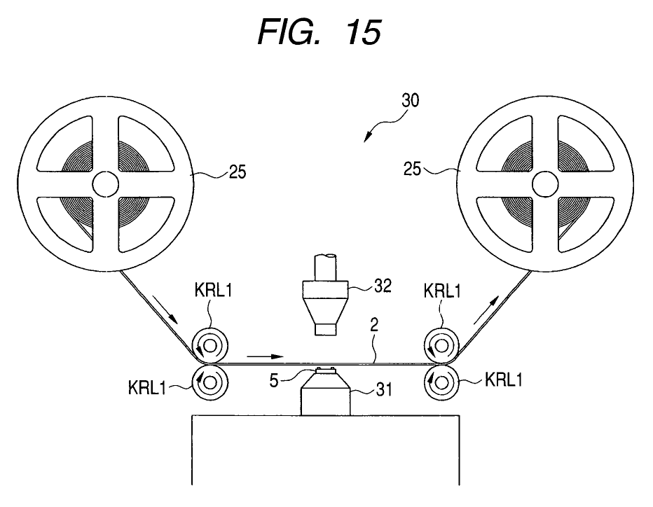

Next, as shown in FIG. 15, the reel 25 is mounted on a inner lead bonder 30 comprising a bonding stage 31 and a bonding tool 32, and the chip 5 is bonded to the antenna 3 while moving the insulating film 2 along the top surface of the bonding stage 31 (process P3).

A drive roller KRL1 that moves the insulating film 2 is used in a set of the two having the same dimensions and the same specifications of rotation speed etc. and the two drive rollers KRL1 sandwich the insulating film 2 and moves the insulating film 2 by frictional force. In addition, all of the four drive rollers KRL1 shown in FIG. 15 have the same specifications. When moving the insulating film 2, by applying such a system, it is possible to handle a thin insulating film 2 and convey the insulating film at a high speed with less damage to the insulating film 2. In addition, the drive roller KRL1 operates by obtaining power from a pulse motor, not shown in FIG. 15.

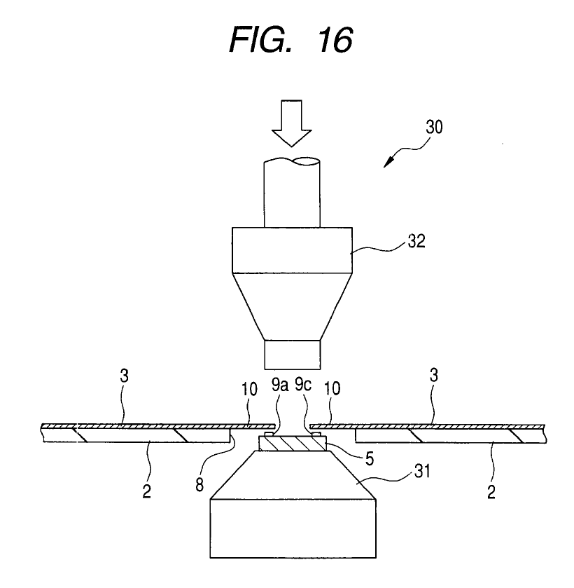

In order to bond the chip 5 to the antenna 3, the chip 5 is mounted on the bonding stage 31 heated to a temperature of about 80° C., as shown in FIG. 16 (enlarged view of critical parts of FIG. 15), and after the device hole 8 of the insulating film 2 is positioned right above the chip 5, the bonding tool 32 heated to a temperature of about 350° C. is pressed against the top surface of the lead 10 protruding to the inside of the device hole 8 and thus the Au bumps (9a to 9d) and the lead 10 are contacted with each other. At this time, by applying predetermined ultrasonic waves and load to the bonding tool 32 for about 0.2 sec., an Au/Al junction is formed at the interface between the leads 10 and the Au bumps (9a to 9d), and the Au bumps (9a to 9d) and the leads 10 are bonded to each other.

Next, a new chip 5 is mounted on the bonding stage 31 and after the insulating film 2 is moved by one pitch of the antenna 3, the same operation as that described above is carried out and thus the chip 5 is bonded to the antenna 3. By repeating the same operation as that described above, the chips 5 are bonded to all of the antennas 3 formed on the insulating film 2. The insulating film 2 for which the bonding work of the chip 5 and the antenna 3 has been completed is conveyed to the next resin sealing process in a state of being wound around the reel 25.

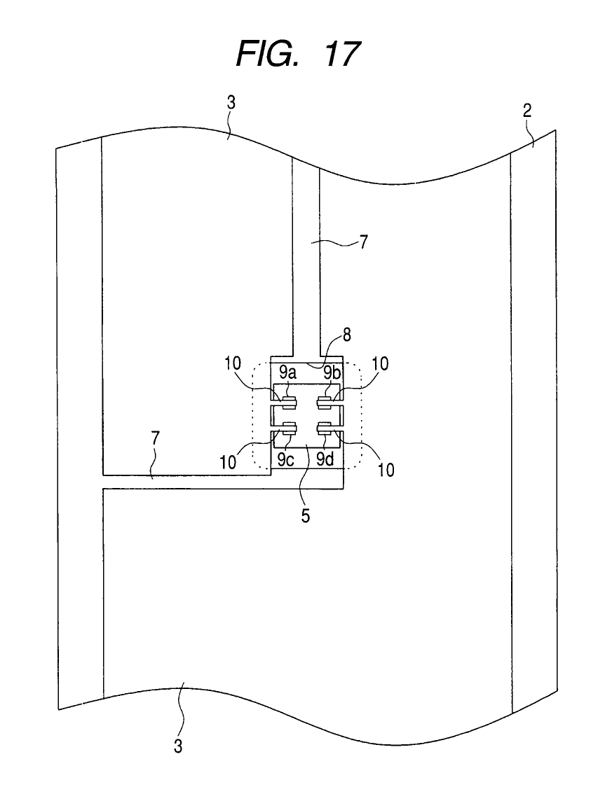

In order to improve the reliability of bonding of the Au bumps (9a to 9d) and the leads 10, it is recommended to extend the four leads 10 in the direction perpendicular to the longitudinal direction of the antenna 3 as shown in FIG. 17. If the four leads 10 are extended in the direction parallel to the longitudinal direction of the antenna 3 as shown in FIG. 18, there is the possibility that the reliability of bonding between both may be reduced when the completed inlet 1 is bent, because a strong tensile stress is generated at the junction of the Au bumps (9a to 9d) and the leads 10.

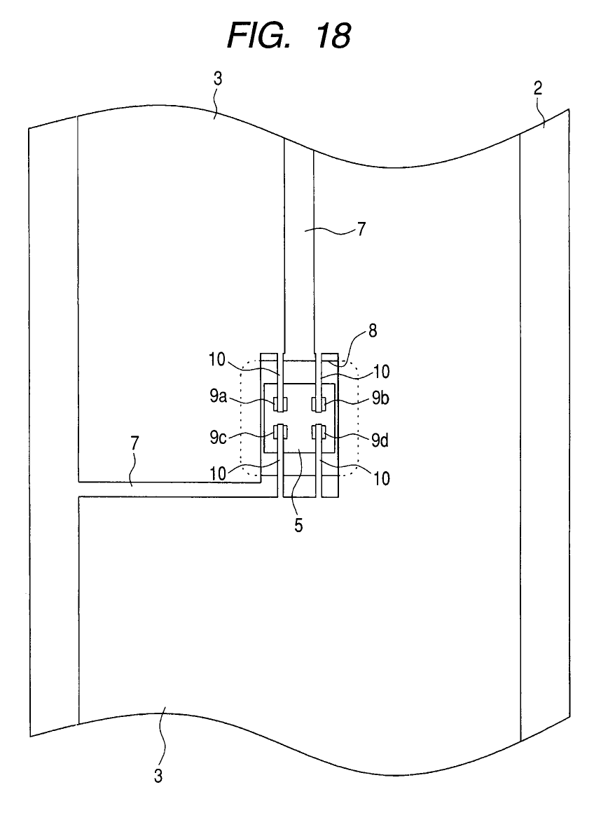

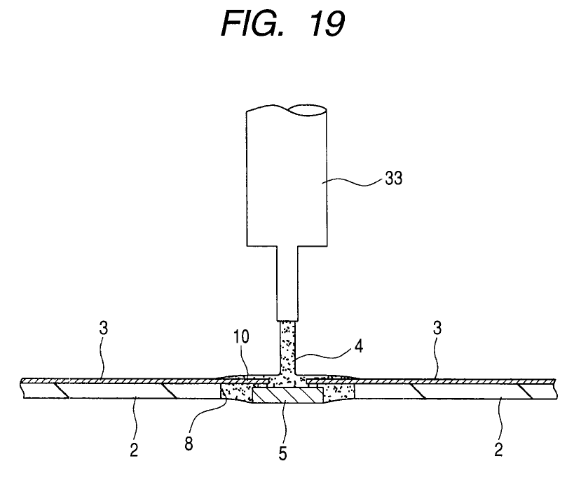

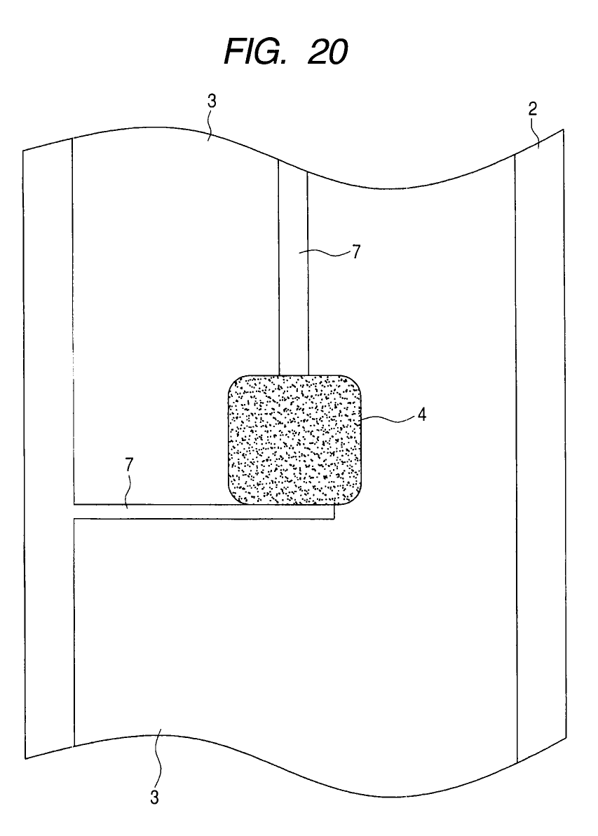

In the resin sealing process of the chip 5, the potting resin 4 is supplied to the top surface and the side of the chip 5 mounted inside the device hole 8 using a dispenser 33 etc., as shown in FIG. 19 and FIG. 20 (process P4).

Next, the potting resin 4 is subjected to pre-baking processing at a temperature of about 12° C. in a heating furnace (process P5). Although not shown schematically, also in the resin sealing process, the potting resin 4 is dispensed and pre-baked while moving the insulating film 2. The insulating film 2 for which dispensing and pre-baking of the potting resin 4 have been completed is conveyed to the heating furnace, where subsequent baking processing is carried out, in a state of being wound around the reel 25, and is subjected to baking processing at a temperature of about 120° C. (process P6).

The insulating film 2 for which the above-mentioned baking processing has been completed is conveyed to the next process in a state of being wound around the reel 25. Here, a structure in which the chip 5 is mounted on the antenna 3 and the chip 5 is sealed with the potting resin 4 is subjected to a sampling inspection of external appearance. Here, instead of inspecting external appearances of all the structures, a predetermined number of structures extracted at random are subjected to the external appearance inspection (process P7). In other words, when an external appearance defect is found, the defect is analyzed, a defective portion of the manufacturing process of the inlet 1 is identified in the areas such as the manufacturing apparatus, materials, etc., used up to process P6, and action is taken to prevent the occurrence of defect by the feedback to the manufacture of the inlet 1 afterward. In addition, the external appearance defect referred to here includes one or more of adhesion of foreign matter to the structure, flows on the structure, poor sealing of the potting resin 4 (poor wettability), damage such as chipping of the chip 5, undesirable deformation of the structure, and poor recognizability of the above-described identification mark formed (stamped) on the antenna 3.

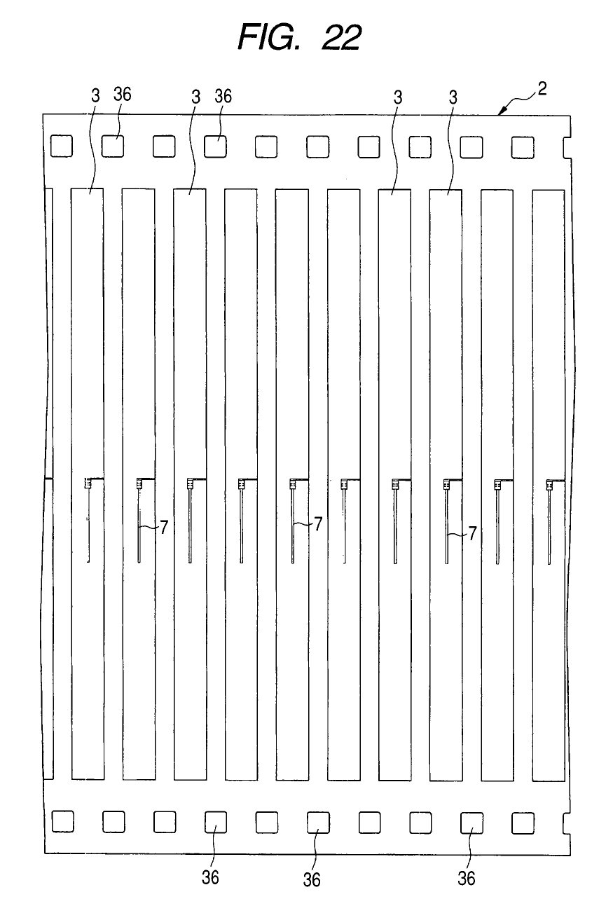

When there is a request from a customer, sprocket holes 36 for conveying the insulating film 2 are formed at predetermined intervals on both sides of the insulating film 2 as shown in FIG. 22 (process P8). The sprocket hole 36 can be formed by punching out part of the insulating film 2. On the other hand, when these sprocket holes 36 are not formed, it is possible to reduce the cost required for forming the sprocket hole 36.

Next, for each of the above-mentioned structures which will be the inlet 1, the following processes are carried out sequentially; a communication characteristic test (process P9), an external appearance inspection of the potting resin 4 (process P10) (refer to FIG. 20), an external appearance inspection of the identification mark given to the antenna 3 (process P11), and classification of good parts after processes P10, P11 (process P12).

Next, the number of final good parts and the number of defective parts are checked, respectively (process P14). Then, the insulating film 2 wound around the reel 25 is packed and delivered (process P15), and is shipped to the customer side (process P16). In this case, it is possible to obtain the individual inlets 1 by cutting the insulating film 2 between the antennas 3 at the customer side. In addition, it may also be possible to ship the inlets 1 in a state of being cut into pieces individually at the manufacturer side (shipping side) in response to a request of a customer. It may also be possible to randomly sample a predetermined number of insulating films 2 to carry out the same communication characteristic test as that in process P9 after packing and delivery.

Next, a process for incorporating the inlet 1 manufactured as described above into a contactless electronic tag will be described. The contactless electronic tag in the present first embodiment is, for example, of label seal type and is intended to manage supply of commodity goods by being pasted to the surface of a good.

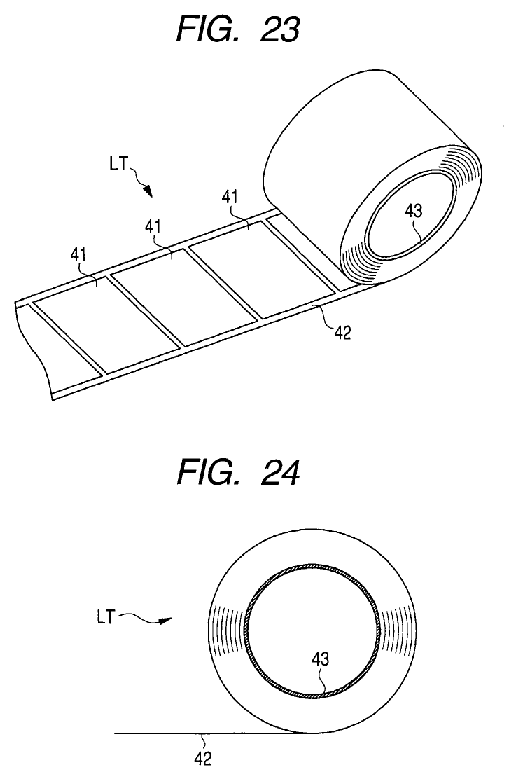

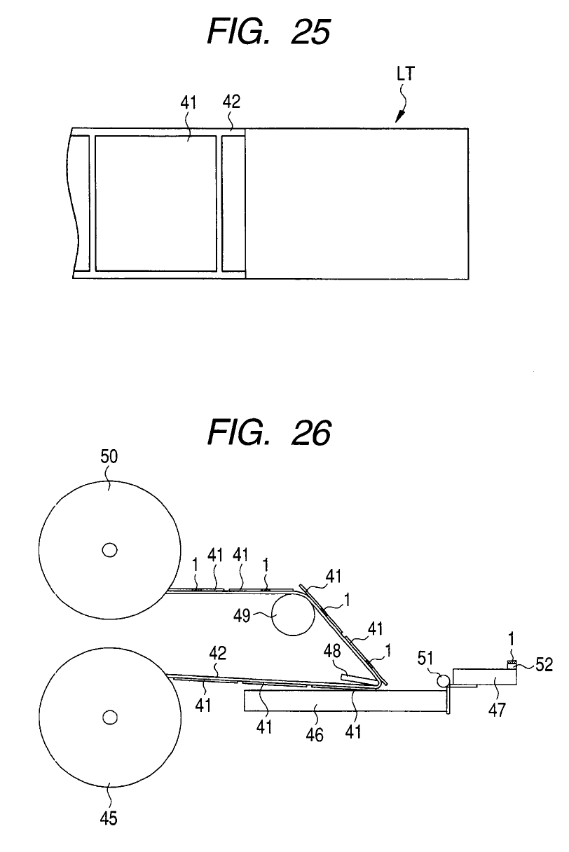

FIG. 23, FIG. 24, and FIG. 25 are a perspective view of critical parts, a side view of critical parts, and a plan view of critical parts, respectively, of a label seal used for the manufacture of the contactless electronic tag in the present first embodiment. As shown in FIG. 23 to FIG. 25, a label seal (tag substrate) 41 made of paper in the present first embodiment is a label seal of type with general strong adhesion, having a label surface (second main surface) to which various prints are made and an adhesive surface (first main surface) on the opposite side of the label surface, and is pasted continuously at predetermined intervals to base paper 42 in the form of a continuous tape and is supplied as a label tape LT in a state in which the base paper 42 is wound around a core part 43. Such a label tape LT is attached to a work unit as shown in FIG. 26 to FIG. 28. The work unit is configured by a tape supply reel 45, a paste stage 46, a rotation plate 47, a label separation plate 48, a guide shaft 49, a tape wind reel 50, etc. In addition, the paste stage 46 and the rotation plate 47 are linked with each other via a hinge 51 and the structure is such that the rotation plate 47 rotates toward the fixed paste stage 46. The rotation plate 47 comprises an inlet holder 52 formed by a silicon rubber having a thickness of, for example, about 1 mm and substantially the same planar shape as that of the inlet 1, and the inlet holder 52 comes into contact with a predetermined position of the paste stage 46 by the rotational movement. In addition, it is possible to pull out the base paper 42 to which the label seal 41 is pasted from the tape supply reel 45 and wind it around the tape wind reel 50 by, for example, operating a handle (not shown) linked with the tape wind reel 50.

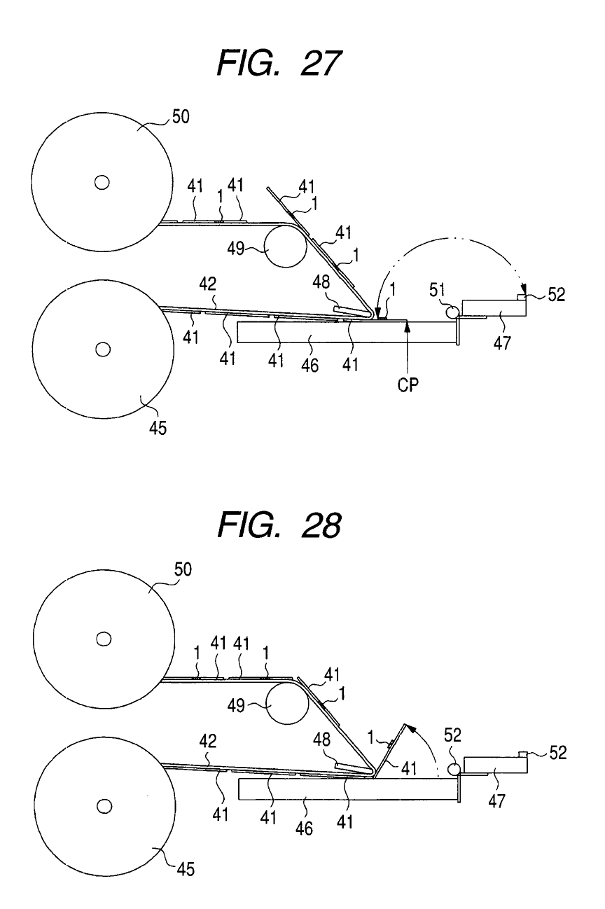

The base paper 42 pasted with the label seal 41 is pulled out from the tape supply reel 45 so that the paste stage 46 and the label seal 41 face to each other and, at a predetermined position on the paste stage 46, the convey route is changed acutely (in such a manner as to form an acute angle with the chamfered portion as its vertex) by the label separation plate 48 in contact with the surface of the base paper 42 to which the label seal 41 is not pasted. The chamfered portion of the label separation plate 48 which contacts with the base paper 42 has been subjected to chamfering work with a predetermined radius of curvature. Then, the base paper 42 is guided through the convey route by the guide shaft 49 in contact with the surface of the base paper 42 to which the label seal 41 is not pasted, and wound around the tape wind reel 50. When the convey route of the base paper 42 is changed by the label separation plate 48, a phenomenon as described below occurs. In other words, the label seal 41 starts to be separated toward the paste stage 46 of the label seal 41 at the position where the convey route is changed (refer to FIG. 27) and when the end portion of the label seal 41 passes through the position where the convey route is changed, the label seal 41 is not completely separated off and by the action of restoring force, returns back to the position of the base paper 42, to which it was originally pasted, in such a manner as to rise up from the paste stage 46 (refer to FIG. 28) and it is pasted back to the base paper 42.

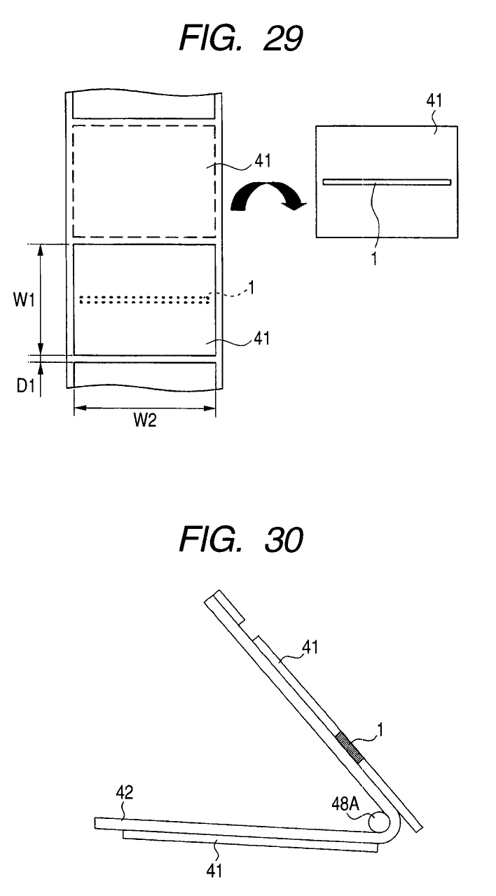

In the present first embodiment, the inlet 1 is pasted in precise position on the adhesive surface of the label seal 41 that appears when the label seal 41 is separated from the base paper 42 by utilizing the above-mentioned phenomenon. In addition, as shown in FIG. 29, in the present first embodiment, width W1 of the label seal 41 in the direction of convey of the base paper 42 is about 74 mm, width W2 in the direction that intersects the width W1 is about 62 mm, its thickness including the adhesive of the adhesive surface is about 50 to 100 μm, a distance D1 between neighboring label seals 41 is about 3 to 5 mm, and the thickness of the base paper 42 is about 30 to 80 μm. The adhesive surface of the label seal 41 faces the base paper 42 when the label seal 41 is pasted to the base paper 42. In addition, the chamfering work applied to the portion where the label separation plate 48 comes into contact with the base paper 42 is such that the radius of curvature is about 1 to 5 mm, and preferably, about 1.5 mm, and it is made smaller as the label seal 41 becomes thinner.

First, one inlet 1 is placed on the inlet holder 52 with its planar shape matched therewith (refer to FIG. 26). The placed inlet 1 is held by the inlet holder 52 with the adhesion that the inlet holder 52 itself has. The adhesion of the inlet holder 52 is weaker than that of the adhesive applied to the adhesive surface of the label seal 41.

Next, the handle linked with the tape wind reel 50 is operated to pull out the base paper 42 from the tape supply reel 45, and the label seal 41 is separated onto the paste stage 46 at the position where the convey route of the base paper 42 is changed by the label separation plate 48. Then, when the front end of the label seal 41 that begins to separate reaches a positioning mark CP given to the surface of the paste stage 46, the pulling out of the base paper 41 is stopped. Next, under this circumstance, the rotation plate 47 is rotated and the inlet 1 held by the inlet holder 52 is pressed against the adhesive surface of the label seal 41. Then, the rotation plate 47 is rotated in the reverse direction to return to the original position. As described above, since the adhesion of the inlet holder 52 is weaker than that of the adhesive applied to the adhesive surface of the label seal 41, the inlet 1 is transferred from the inlet holder 52 to the adhesive surface of the label seal 41 (refer to FIG. 27) when the rotation plate 47 is returned back to its original position. By pasting the inlet 1 to the adhesive surface of the label seal 41 in this manner, it is possible to paste the inlet 1 with precision and efficiency to a predetermined position in the adhesive surface.

Subsequently, by operating the handle linked with the tape wind reel 50, the winding of the base paper 42 by the tape wind reel 50 (pulling out of the base paper 42 from the tape supply reel 45) is resumed. By these operations, part of the base paper 42 is separated therefrom and pulled out to the paste stage 46 and then, the label seal 41, to the adhesive surface of which the inlet 1 has been pasted, returns to the position of the base paper 42 where originally pasted, in such a manner as to rise from the paste stage 46 by the action of the restoring force when its end portion reaches the position where the convey route of the base paper 42 is changed by the label separation plate 48, and is pasted back to the base paper 42, and it is wound around the tape wind reel 50 together with the base paper 42 (refer to FIG. 28 and FIG. 29). In the present first embodiment, it is preferable to perform the series of operations from the separation of the label seal 41 from the base paper 42 to the pasting-back, at a rate of about 0.5 to 1.0 sec per label seal 41. Due to this, when the label seal 41 is pasted back to the position where originally pasted, it becomes also possible to easily paste back with an accurate positional precision. As a result, it is possible to shorten the time required for the series of operations for pasting the inlet 1 to the label seal 41. In addition, even if the label seal 41 changes in size, the same process can be applied easily, and therefore, it is possible to perform the series of operations to paste the inlet 1 to the label seals 41 of various sizes in a brief time and at a low cost.

By performing the above-mentioned series of operations to all of the label seals 41 pulled out from the tape supply reel 45, the inlets 1 are pasted to the label seals 41. After the label seal 41 is pasted back to the base paper 42, the inlet 1 is situated between the label seal 41 and the base paper 42 and is surrounded by the label seal 41 and the base paper 42, as a result.

In the above-mentioned first embodiment, in the work unit used to paste the inlet 1 to the label seal 41, a case is described where the label separation plate 48 has been subjected to the chamfering machining with a predetermined radius of curvature at the portion that comes into contact with the base paper 42, however, it may also be possible to, as shown in FIG. 30, use a circular, cylindrical shaft (cylindrical jig) 48A the section of which has a value of radius substantially the same value of the above-described radius of curvature, instead of the label separation plate 48. In addition, it may also be possible to pull out the base paper 42 from the tape supply reel 45 by operating the tape wind reel 50 and the tape supply reel 45 using a pulse motor etc. as a power source instead of the human-powered handle operation.

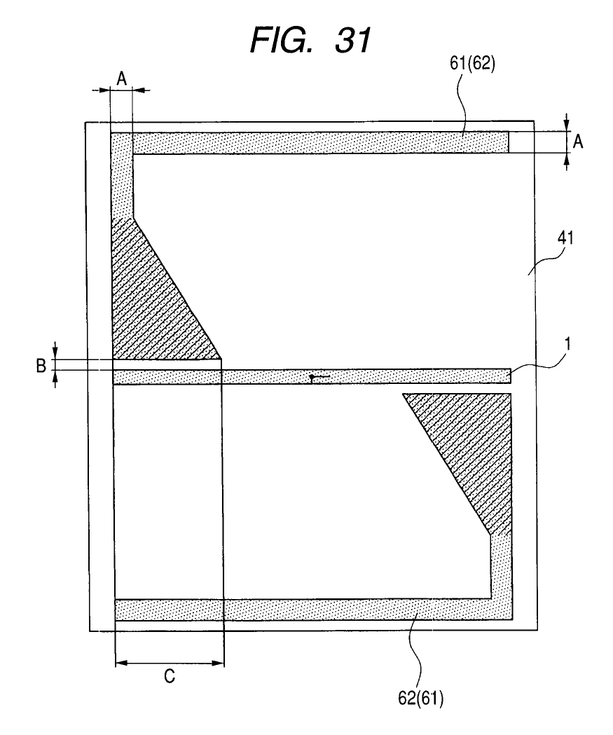

One of the objects of the present first embodiment is to extend the communication range of the contactless electronic tag. To this end, in the present first embodiment, a wave director 61 and a reflector 62 formed by a metal foil (Al foil (second conductive film) etc.) having a planar pattern in the shape of an approximate L letter, for example, as shown in FIG. 31, are pasted to the adhesive surface of the label seal 41. The wave director (auxiliary antenna section) 61 and the reflector (auxiliary antenna section) 62 are formed by the planar pattern of the same dimensions and the respective positions may be reversed and one of them serves as the wave director 61 and the other serves as the reflector 62. In addition, the wave director 61 and the reflector 62 are arranged in a point symmetric manner (in the shape of an approximate S letter, including the inlet 1) on the adhesive surface of the label seal 41 via the inlet 1 in between (as a point of symmetry). The wave director 61 and the reflector 62 are formed by a part having a relatively wide width (shown by attaching a hatch of slashes) and a part having a relatively narrow width, and the end portion having the greatest width among the relatively wide parts is placed in opposition to the inlet 1 at a distance in parallel thereto. In the present first embodiment, width A of the relatively narrow part may be exemplified as about 3 to 5 mm.

In addition, the wave director 61 and the reflector 62 are in close proximity to the periphery (peripheral area) of the label seal 41 and pasted along its periphery. With such a structure in which the wave director 61 and the reflector 62 are pasted to such positions, it is possible to easily paste the wave director 61 and the reflector 62, because it is possible to prevent the device (jig) used to paste the wave director 61 and the reflector 62 from sticking to the adhesive surface of the label seal more than necessary during the pasting process of the wave director 61 and the reflector 62. In other words, it becomes possible to improve mass productivity of the contactless electronic tag in the present first embodiment.

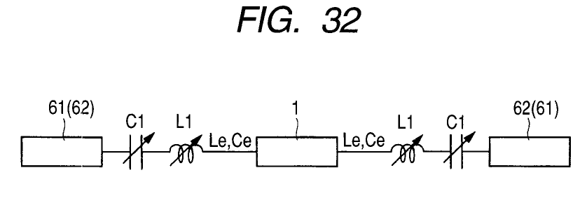

By the way, in case of the contactless electronic tag in which only the inlet 1 is pasted to the adhesive surface of the label seal 41, the radio waves (circularly polarized waves) radiated from the antenna of a reader (external communication device) that performs data communication with the contactless electronic tag are received only by the inlet as a result. Because of this, circular polarization loss (power loss) occurs and the communication range of the contactless electronic tag is shortened as a result. On the other hand, by arranging the wave director 61 and the reflector 62 having the planar pattern in the above-mentioned present first embodiment on the adhesive surface of the label seal 41 in a point symmetric manner (in the shape of an approximate S letter, including the inlet 1) via the inlet in between, it becomes possible to efficiently receive the circularly polarized waves. Since a gap having a width B is provided between the end portion having the greatest width among the relatively wide parts of the wave director 61 and the reflector 62 and the inlet 1, so that the end portions face the inlet with a width C, an inductor L1 and a capacitor C1 in an equivalent circuit as shown in FIG. 32 are formed. The inductor L1 and the capacitor C1 are variable respectively and their values are determined by the width B and the width C described above. Due to the formation of the inductor L1 and the capacitor C1 as described above, a resonance frequency f of a circuit provided in the contactless electronic tag of the present first embodiment is expressed by an expression shown as a mathematical expression 1. In the mathematical expression 1, Le and Ce are the effective inductance and the effective electrostatic capacitance of the circuit, respectively.

### (Mathematical Expression 1)

In other words, from the relationship between the widths B, C and the resonance frequency f described above, a capacitor (compacted capacitor) is provided between the inlet 1 and the wave director 61 (reflector 62) and a matching circuit (resonance circuit) is formed as a result in which the inlet 1 and the wave director 61 (reflector 62) are connected by proximate junction (capacitive coupling) via the capacitance (compacted capacitor). The matching circuit (resonance circuit) operates at the resonance frequency f. Because of this, it becomes possible to reduce the circular polarization loss of the contactless electronic tag in the present first embodiment, and therefore, it becomes possible to lengthen the communication range of the contactless electronic tag. According to the experiment conducted by the inventors of the present invention, while the communication range of the contactless electronic tag without the pasted wave director 61 and reflector 62 was about 58 cm, the communication range of the contactless electronic tag in the present embodiment to which the wave director 61 and the reflector 62 have been pasted could be lengthened up to about 100 cm.

With such a contactless electronic tag in the present first embodiment, it is possible to considerably extend the communication directionality of the contactless electronic tag because the wave director 61 and the reflector 62 are arranged on the adhesive surface of the label seal 41 in a point symmetric manner via the inlet 1 in between. Due to this, it becomes possible to communicate with the reader without the need to consider the direction of the contactless electronic tag, and therefore, it becomes also possible to give considerable freedom for the position of pasting (attachment) of the contactless electronic tag itself.

In addition, with such a contactless electronic tag in the present first embodiment, it is possible to lengthen the communication range of the contactless electronic tag, and therefore, when the contactless electronic tag is applied to the process (work) of automatic assortment of items or to a type of business (circumstance) in which human beings or items pass through a gate, it is no longer necessary to near the contactless electronic tag to and hold it over the reader. Therefore, it becomes possible to simplify the management etc. of human beings and distribution of items.

In addition, with such a contactless electronic tag in the present first embodiment, since it is possible to make the wave director 61 and the reflector 62 from the same material and make them have the same shape (same pattern), the material cost can be reduced and the manufacturing cost of the contactless electronic tag in the present first embodiment can be reduced.

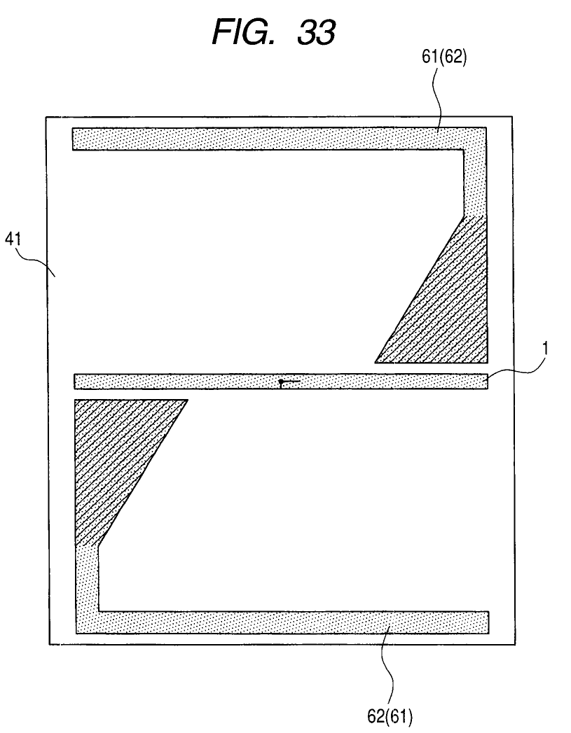

By the way, the wave director 61 and the reflector 62 on the adhesive surface of the label seal 41 may have a pattern as shown in FIG. 33, which is the pattern of the wave director 61 and the reflector 62 shown in FIG. 31 reversed front-side back. With such a contactless electronic tag, to which the wave director 61 and the reflector 62 having the reversed pattern are attached, it is also possible to obtain the same characteristic as that of the contactless electronic tag shown in FIG. 31.

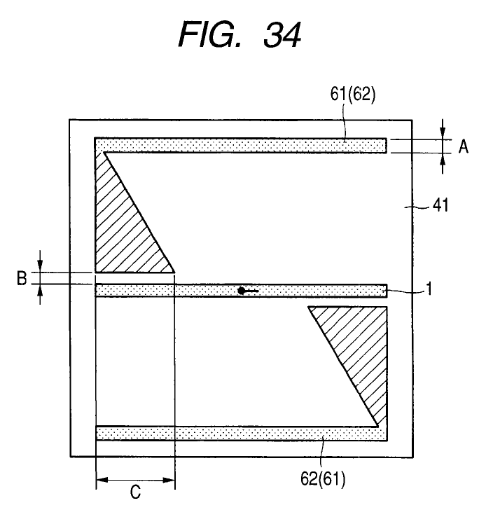

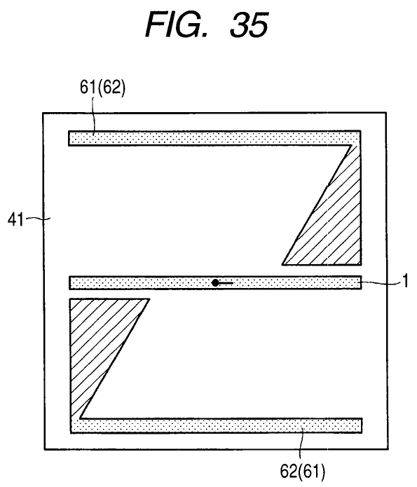

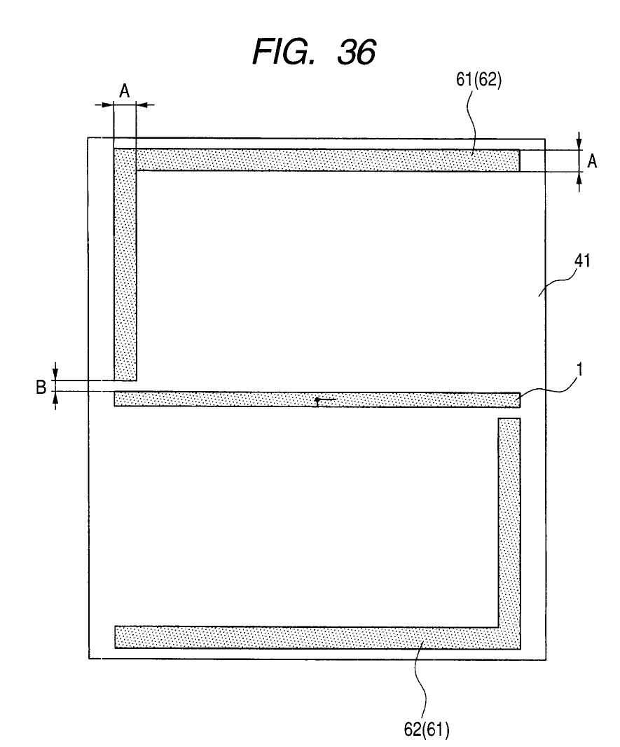

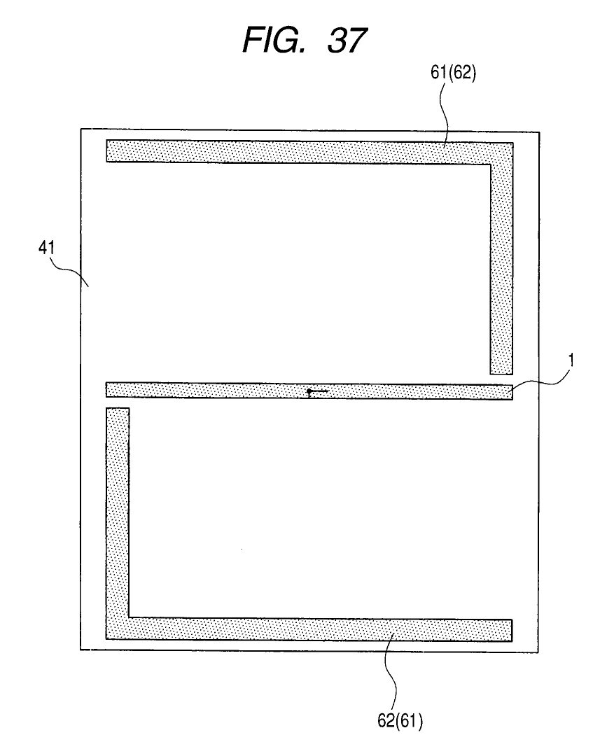

In addition, the pattern of the wave director 61 and the reflector 62 on the adhesive surface of the label seal 41 may be formed so that the area of the relatively wide part (shown by attaching a hatch of slashes) in the pattern of the wave director 61 and the reflector 62 shown in the above-mentioned FIG. 31 is widened, or oppositely, may be formed so that all of the widths are the width A by omitting the wide part as shown in FIG. 36. Even with such a contactless electronic tag to which the wave director 61 and the reflector 62 having such a pattern have been attached, it is possible to obtain the same characteristic as that of the contactless electronic tag shown in FIG. 31. Further, as shown in FIG. 35 and FIG. 37, even with patterns of the wave director 61 and the reflector 62 obtained by reversing the patterns of the wave director 61 and the reflector 62 shown in FIG. 34 and FIG. 36, it is also possible to obtain the same characteristic as that of the patterns of the wave director 61 and the reflector 62 shown in FIG. 31, FIG. 34, and FIG. 36.

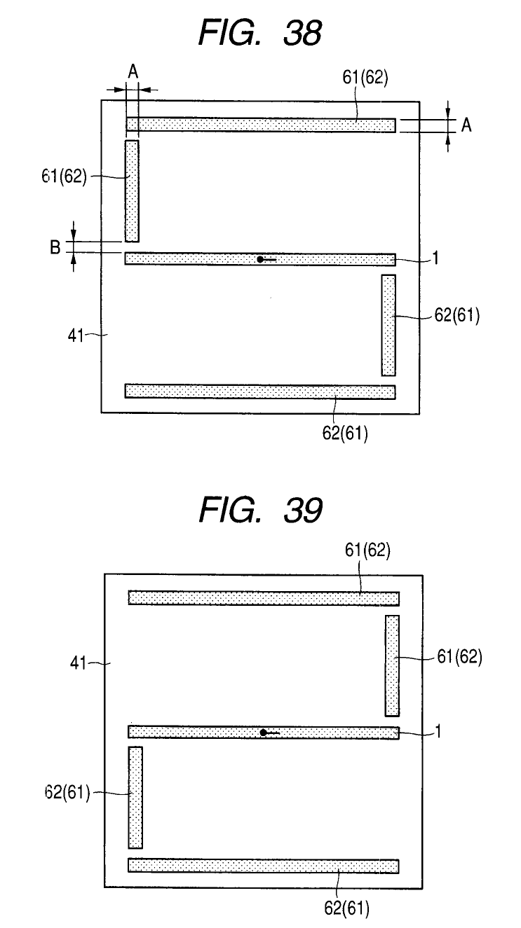

Furthermore, the pattern of the wave director 61 and the reflector 62 shown in FIG. 36 and FIG. 37 may be formed by arranging plural metal foils (Al foil (second conductive film) etc.) separately as shown in FIG. 38 and FIG. 39, and in this case, a capacitance (compacted capacitor) is provided also between the gap of the plural metal foils forming the wave director 61 and the reflector 62, which functions as a matching circuit (resonance circuit) and it becomes possible to reduce the circular polarization loss.

Next, a process for pasting the wave director 61 and the reflector 62 described above to the label seal 41 will be described.

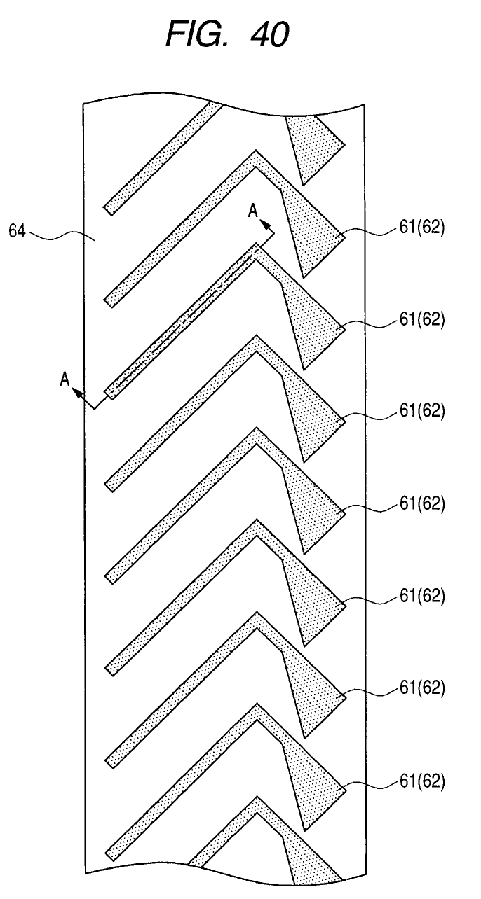

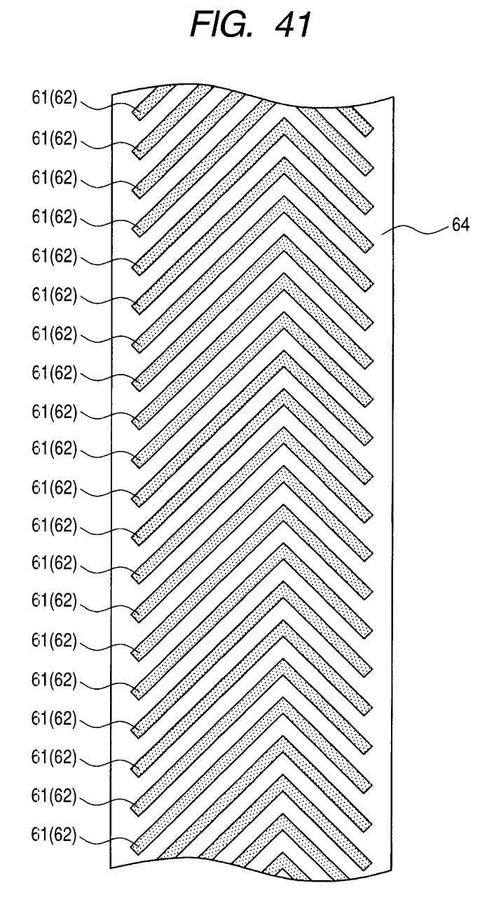

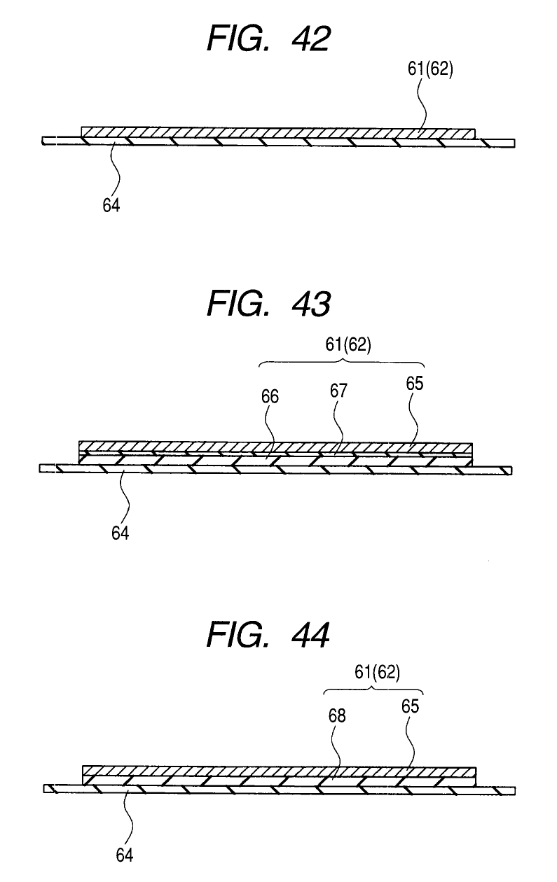

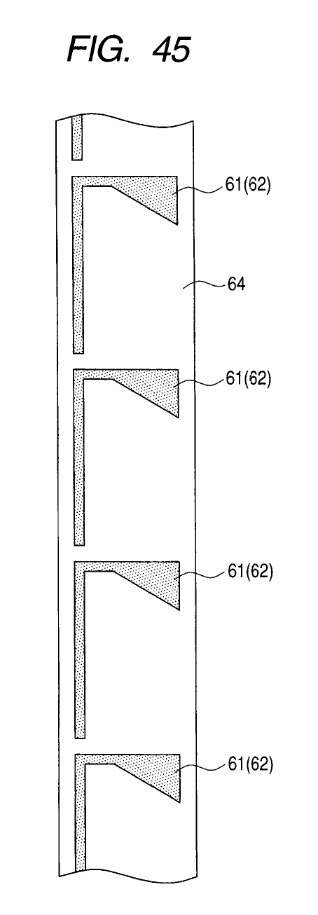

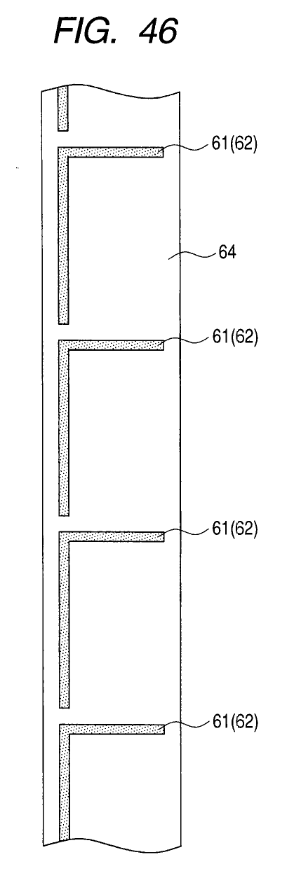

The wave director 61 and the reflector 62 are supplied, for example, as a seal material in the form of a tape of general strong adhesion as shown in FIG. 40 and FIG. 41. FIG. 40 shows a seal material corresponding to the case where the wave director 61 and the reflector 62 have the pattern shown in the above-mentioned FIG. 31, and FIG. 41 shows a seal material corresponding to the case where the wave director 61 and the reflector 62 have the pattern shown in the above-mentioned FIG. 36. In addition, various structures of the seal materials can be exemplified as shown in FIG. 42 to FIG. 44 and they respectively correspond to the section along the A-A line in FIG. 40.

As shown in FIG. 40 and FIG. 41, the wave director 61 and the reflector 62 have an adhesive surface in opposition to the label seal 41 when pasted to the above-mentioned label seal 41 and are repetitively pasted to a base paper 64 in the form of a continuous tape at predetermined intervals as with the label seal 41, and supplied as a tape material in the state in which the base paper 64 is wound around the core. Various structures of the wave director 61 and the reflector 62 pasted to the base paper 64 can be exemplified as described above. The structures include, for example, one formed by only aluminum foils as shown in FIG. 42, one formed by pasting an aluminum foil 65 and a polyester resin foil 66 to each other via an adhesive material 67, in which the side of the polyester resin foil 66 will serve as an adhesive surface, as shown in FIG. 43, one formed by evaporating the aluminum foil 65 on a PET (Polyethylene terephthalate) material 68, in which the side of the PET material 68 will serve as an adhesive surface as shown in FIG. 44, etc.

FIG. 40 and FIG. 41 show the case where the wave director 61 and the reflector 62 are pasted to the base paper 64 so that the direction in which the pattern of the wave director 61 and the reflector 62 in the shape of an approximate L letter extends is about 45° with respect to the direction in which the base paper 64 extends. The pasting angle of the wave director 61 and the reflector 62 with respect to the base paper 64 is not limited to this angle, and it may also be possible for the direction in which the pattern of the wave director 61 and the reflector 62 in the shape of an approximate L letter extends to be parallel or perpendicular to the direction in which the base paper 64 extends. The pasting angle of the wave director 61 and the reflector 62 with respect to the base paper 64 is set appropriately corresponding to the configuration of the work unit that pastes the wave director 61 and the reflector 62 to the label seal 41, which will be described later.

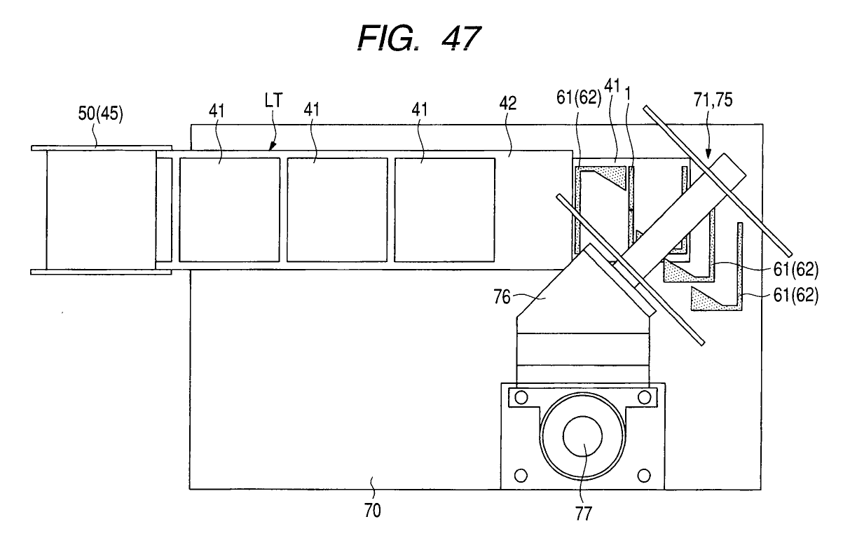

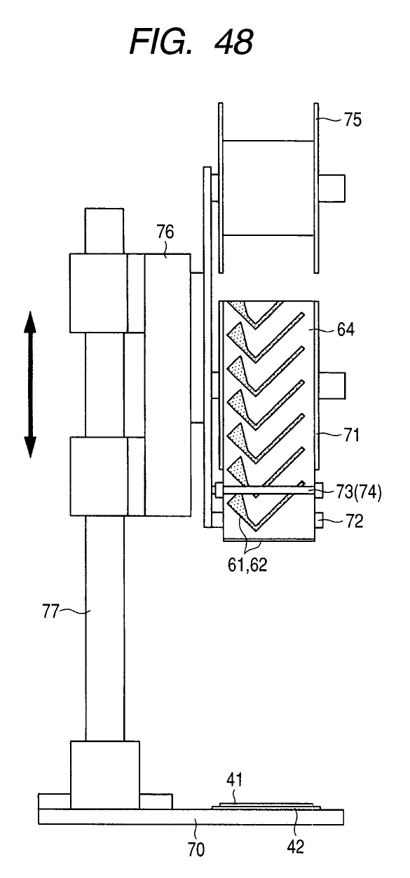

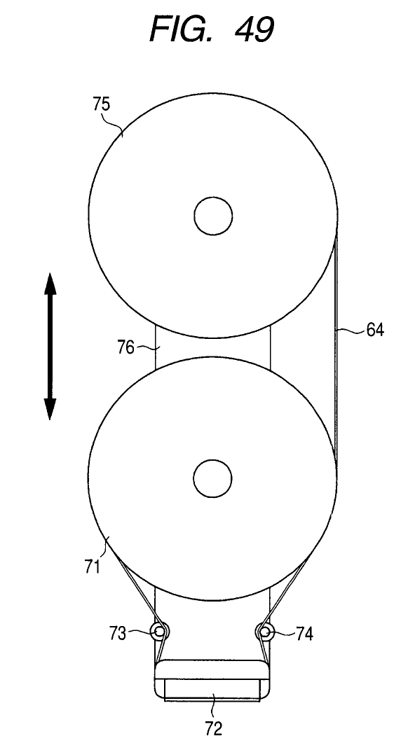

FIG. 47 is a top view of critical parts of the work unit that pastes the wave director 61 and the reflector 62 to the adhesive surface of the label seal 41, FIG. 48 is a side view of critical parts of the apparatus, and FIG. 49 is a side view of other critical parts of the apparatus, respectively showing the case where the tape material composed of the base paper 64 to which the wave director 61 and the reflector 62 have been pasted as shown in FIG. 40 is used.

The work unit shown in FIG. 47 to FIG. 49 is configured with the work unit used when the inlet 1 is pasted to the adhesive surface of the label seal 41 (refer to FIG. 26 to FIG. 28) and a unit (hereinafter, referred to as a pasting unit) that holds the seal material in the form of a tape in which the wave director 61 and the reflector 62 have been pasted to the base paper 64 and pastes the wave director 61 and the reflector 62 to the adhesive surface of the label seal 41, both of the units being attached to a work stage 70. Incidentally, the paste stage 46 shown in FIG. 26 to FIG. 28 is omitted. In addition, for easy understanding of the configuration of the pasting unit, the base paper 64 to which the wave director 61 and the reflector 62 have been pasted is omitted and not shown schematically in FIG. 47. The present first embodiment exemplifies the pasting of the wave director 61 and the reflector 62 to the adhesive surface of the label seal 41 to which the inlet 1 has already been pasted, however, it may also be possible to paste the inlet 1 after pasting the wave director 61 and the reflector 62.

The above-mentioned pasting unit is configured by a tape supply reel 71, a press tool 72, guide shafts 73, 74, a tape wind reel 75, a holder 76, a support 77, etc. As the tape supply reel 71 and the tape wind reel 75, it is possible to use the same structures as that of the tape supply reel 45 and the tape wind reel 50 that have wound (or wind) the label tape LT to which the above-described label seal 41 has been pasted, respectively. The support 77 is fixed on the work stage 70 and the holder 76 that holds the tape supply reel 71, the press tool 72, the guide shafts 73, 74, and the tape wind reel 75 has a structure which can go up or down along the support 77. In addition, by operating, for example, the handle (not shown schematically) linked with the tape wind reel 75, it is possible to pull out from the tape supply reel 71 the base paper 64 to which the wave director 61 and the reflector 62 have been pasted and wind it around the tape wind reel 75 via the guide shaft 73, the press tool 72, and the guide shaft 74 sequentially. When the base paper 64 passes through the press tool 72, the wave director 61 and the reflector 62 face the work stage 70. Instead of the human-powered handle operation, it may also be possible to pull out the base paper 64 from the tape supply reel 71 by activating the tape wind reel 75 and the tape supply reel 71 using a pulse motor etc. as a power source.

As with the case described above using FIG. 26 to FIG. 28, the base paper 42 to which the label seal 41 is pasted is pulled out from the tape supply reel 45 so that the work stage 70 and the label seal 41 face each other and, at a predetermined position on the work stage 70, the convey route is changed acutely (in such a manner as to form an acute angle with the chamfered portion as its vertex) by the label separation plate 48 (refer to FIG. 26 to FIG. 28) in contact with the surface of the base paper 42 to which the label seal 41 is not pasted. As described above, when the convey route of the base paper 42 is changed by the label separation plate 48, separation of the label seal 41 starts toward the work stage 70 at the position where the convey route is changed and when the end portion of the label seal 41 passes through the position where the convey route is changed, the label seal 41 is not completely separated off and by the action of restoring force, it returns to the position of the base paper 42, to which it is originally pasted, in such a manner as to rise up from the work stage 70 and it is pasted back to the base paper 42. In the work unit shown in FIG. 47 to FIG. 49, the pasting unit is arranged so that one of the wave director 61 and the reflector 62 is pasted with positional precision to the adhesive surface of the label seal 41 that appears when the label seal 41 is separated from the base paper 42. In addition, the work unit in the present first embodiment shown in FIG. 47 to FIG. 49 has a structure with which the pasting position of the wave director 61 and the reflector 62 to the adhesive surface of the label seal 41 can be confirmed by a camera, not shown schematically, so that it becomes possible to paste the wave director 61 and the reflector 62 with a higher precision.

First, the handle linked with the tape wind reel 50 is operated to pull out the base paper 42 from the tape supply reel 45 and the label seal 41 is separated onto the work stage 70 at the position where the convey route of the base paper 42 is changed by the label separation plate 48. When the front end of the label seal 41 that begins to separate reaches a positioning mark (not shown) given to the surface of the work stage 70, the pulling out of the base paper 41 is stopped. Then, by operating the handle linked with the tape wind reel 75, one of the wave director 61 and the reflector 62 pasted to the base paper 64 is positioned under the press tool 72. Then, under this situation, the holder 76 is lowered and the one of the wave director 61 and the reflector 62 under the press tool 72 is pressed against the adhesive surface of the label seal 41. By lifting the holder 76, the one of the wave director 61 and the reflector 62 under the press tool 72 separates from the base paper 64 and is transferred and taken (pasted) to a predetermined pasting position on the adhesive surface of the label seal 41. Then, by pasting the wave director 61 and the reflector 62 to the adhesive surface of the label seal 41 in this manner, it becomes possible to paste the wave director 61 and the reflector 62 precisely and efficiently to a predetermined position in the adhesive surface.

Subsequently, by operating the handle linked with the tape wind reel 50, the winding of the base paper 42 by the tape wind reel 50 (pulling out of the base paper 42 from the tape supply reel 45) is resumed. With these operations, part of the base paper 42 is separated therefrom and pulled out to the work stage 70, and the label seal 41, to the adhesive surface of which one of the wave director 61 and the reflector 62 has been pasted, returns to the position of the base paper 42 where originally pasted, in such a manner as to rise from the work stage 70 by the action of the restoring force and is pasted back to the base paper 42 again when the end portion reaches the position where the convey route of the base paper 42 is changed by the label separation plate 48 and it is wound around the tape wind reel 50 together with the base paper 42.

By executing the above-mentioned series of operations to all of the label seals 41 pulled out from the tape supply reel 45, the operation of pasting one of the wave director 61 and the reflector 62 to the label seal 41 is performed. After this, the base paper 42 wound around the tape wind reel 50 is set on the tape supply reel 45 again and the same operations as the above-mentioned series of operations are performed to all of the label seals 41 pulled out from the tape supply reel 45. At this time, the direction in which the base paper 42 is pulled out (the direction of conveyance) is opposite to that at the time of the above-mentioned series of operations, and therefore, it becomes possible to paste the other of the wave director 61 and the reflector 62. After the label seal 41 is pasted back to the base paper 42 again, the wave director 61 and the reflector 62 are situated between the label seal 41 and the base paper 42 and surrounded by the label seal 41 and the base paper 42 as a result.

### Second Embodiment

Next, a contactless electronic tag in a second embodiment will be described.

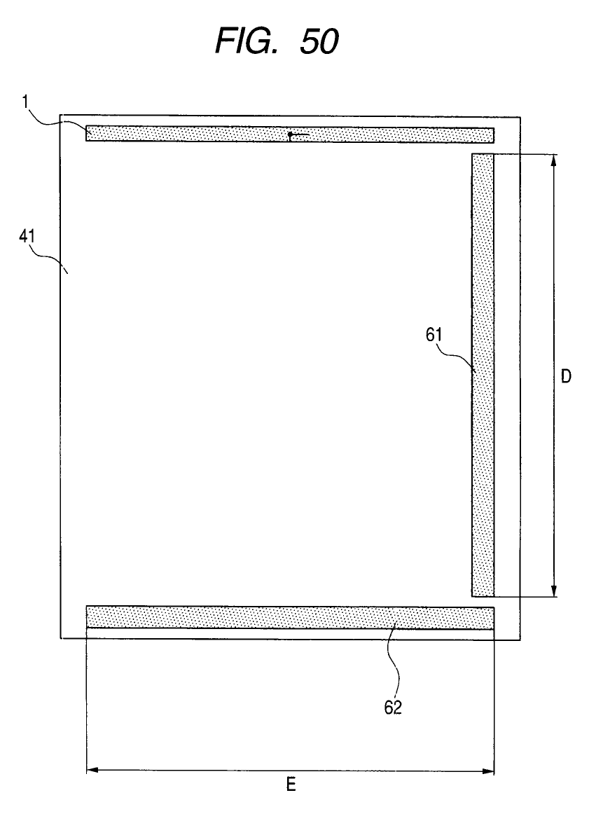

As shown in FIG. 50, the contactless electronic tag in the present second embodiment is of label seal type as the contactless electronic tag in above-mentioned first embodiment but the arrangement pattern of the inlet 1, the wave director 61, and the reflector 62 is different.

In the present second embodiment, the inlet 1 is pasted along one side of the label seal 41 in the vicinity of the one side. The wave director 61 has a planar rectangular shape and its width is the same as the width A shown in FIG. 1 in the above-mentioned first embodiment and a length D in the direction of extension is about 60 mm. The reflector 62 also has a planar rectangular shape as same as the wave director 61 and its width is the same as the width A shown in FIG. 31 in the above-mentioned first embodiment, and a length E in the direction of extension is about 53 mm. The wave director 61 is pasted along one side of the label seal 41 in the direction perpendicular to the direction of extension of the inlet 1 in the vicinity of the one side separately from the inlet 1. The reflector 62 is pasted along one side of the label seal 41 in the direction parallel to the direction of extension of the inlet 1 and perpendicular to the direction of extension of the wave director 61 in the vicinity of the one side separately from the inlet 1 and the wave director 61. In other words, the inlet 1, the wave director 61, and the reflector 62 are pasted to the adhesive surface of the label seal 41 in an arrangement pattern in the shape of an approximate U letter.

Also in the contactless electronic tag in the present second embodiment formed by the label seal 41 in which the inlet 1, the wave director 61, and the reflector 62 are pasted to the adhesive surface in the above-mentioned arrangement pattern, the wave director 61 and the reflector 62 are in close proximity to the periphery of the label seal 41 and pasted along the periphery, as in the contactless electronic tag in the above-mentioned first embodiment. Therefore, when the wave director 61 and the reflector 62 are pasted to the adhesive surface of the label seal 41, it becomes possible to prevent the device (jig) used to paste the wave director 61 and the reflector 62 from sticking to the adhesive surface of the label seal more than necessary, and therefore, it is possible to easily paste the wave director 61 and the reflector 62. In other words, it becomes possible to improve mass productivity of the contactless electronic tag in the present second embodiment.

In addition, also with the contactless electronic tag in the present second embodiment formed by the label seal 41 in which the inlet 1, the wave director 61, and the reflector 62 are pasted to the adhesive surface in the above-mentioned arrangement pattern, as with the contactless electronic tag in the above-mentioned first embodiment, it becomes possible to efficiently receive the radio waves (circularly polarized waves) radiated from the antenna of the reader that performs data communication with the contactless electronic tag while reducing the circular polarization loss. Due to this, it becomes possible to lengthen the communication range of the contactless electronic tag in the present second embodiment.

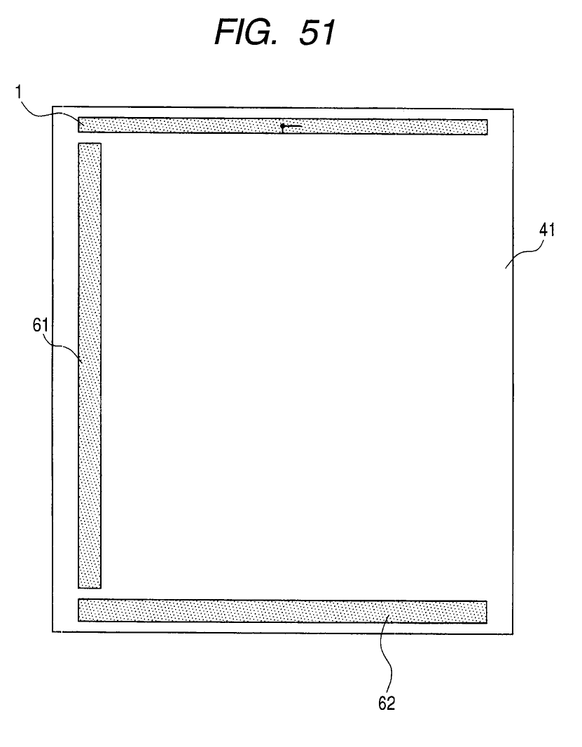

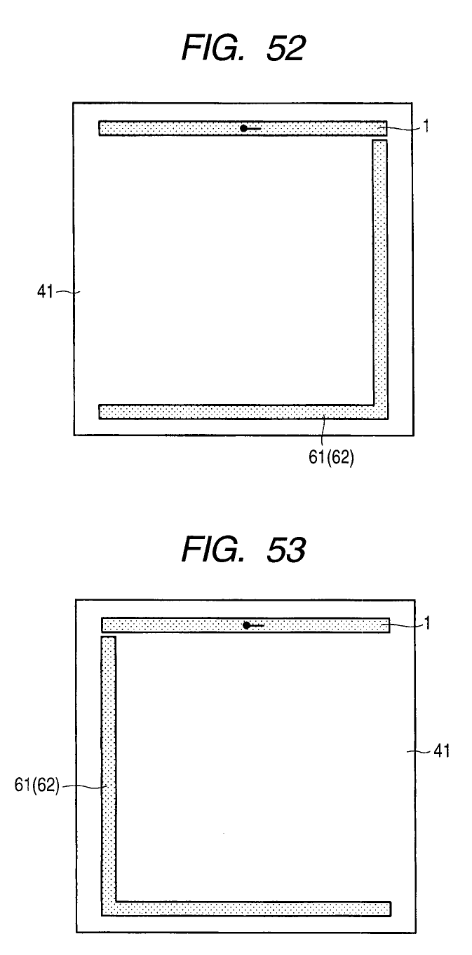

By the way, as shown in FIG. 51, the arrangement pattern of the wave director 61 and the reflector 62 on the adhesive surface of the label seal 41 may be a pattern obtained by reversing the arrangement pattern of the wave director 61 and the reflector 62 shown in the above-mentioned FIG. 50, and also may be a pattern in which the wave director 61 (reflector 62) is integrally formed into the shape of an approximate L letter as shown in FIG. 52 and FIG. 53. Even with the contactless electronic tag to which the wave director 61 (reflector 62) having such a pattern reversed front-side back or a pattern integrally formed into the shape of an approximate L letter has been pasted, it is also possible to obtain the same characteristic as that of the contactless electronic tag shown in FIG. 50.

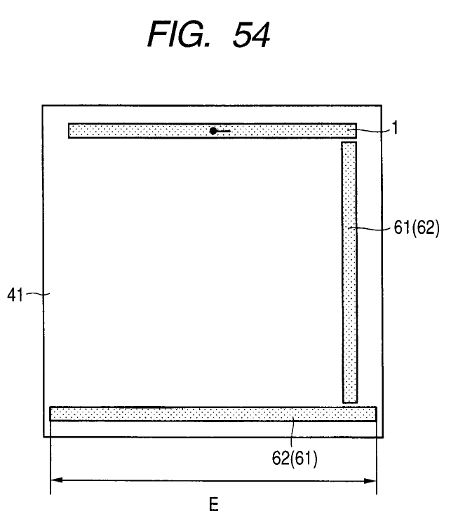

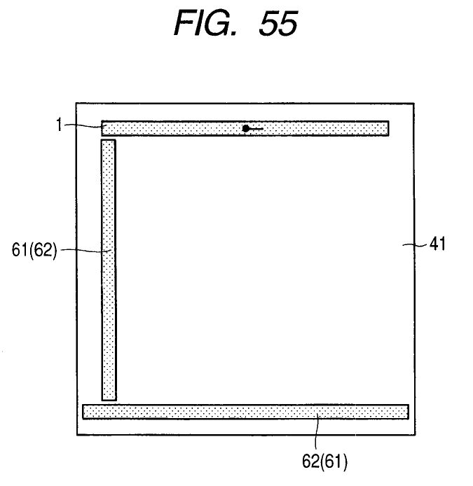

In addition, as shown in FIG. 54 and FIG. 55, it is also possible to form the length E in the direction of extension of the reflector 62 in FIG. 50 and FIG. 51 described above so as to be longer than the length in the direction of extension of the inlet 1 and in this case also, it is possible to obtain the same characteristic as that of the contactless electronic tag shown in FIG. 50.

By the present second embodiment as described above also, it is possible to obtain the same effect as that in the above-mentioned first embodiment.

### Third Embodiment

Next, a contactless electronic tag in a third embodiment will be described.

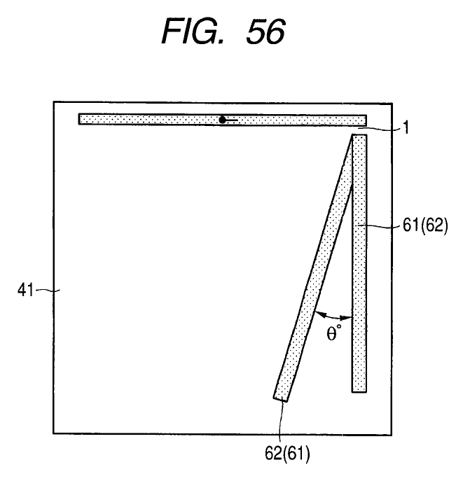

As shown in FIG. 56, the contactless electronic tag in the present third embodiment is of label seal type as same as the contactless electronic tag in above-mentioned first embodiment but the arrangement pattern of the inlet 1, the wave director 61, and the reflector 62 is different.

In the present third embodiment, the inlet 1 is pasted along one side of the label seal 41 in the vicinity of the one side. The wave director 61 is pasted along one side of the label seal 41 in the direction perpendicular to the direction of extension of the inlet 1 in the vicinity of the one side separately from the inlet 1. The reflector 62 is arranged such that one end thereof comes into contact with one end of the wave director 61 in close proximity to the inlet 1 and the direction of extension of the reflector 62 forms an angle (θ) with respect to the direction of extension of the wave director 61. In other words, on the adhesive surface of the label seal 41, the wave director 61 and the reflector 62 are pasted in an arrangement pattern in the shape of an approximate V letter. Here, the one end of the wave director 61 and the one end of the reflector 62 in contact with each other may be connected by the metal foils (Al foil (second conductive film) etc.) forming the wave director and the reflector coming into direct contact with each other, or may be connected indirectly by capacitive coupling via the insulating film between the wave director 61 and the reflector 62. For example, when the wave director 61 and the reflector 62 are formed by only the aluminum foil as shown in FIG. 42, or when the wave director 61 and the reflector 62 are formed from the aluminum foil material by integrally forming them into the shape of an approximate V letter, the aluminum foil of the wave director 62 and the aluminum foil of the reflector 62 are connected directly. In addition, when such one, as shown in FIG. 43 and FIG. 44, formed by pasting the aluminum foil 65 and the polyester resin foil 66 to each other via the adhesive material 67, or such one, as shown in FIG. 44, formed by evaporating the aluminum foil 65 on the PET material 68, etc., are arranged in an overlapping manner as the materials of the wave director 61 and the reflector 62, the result will be as follows. Between the aluminum foil of the wave director 61 and the aluminum foil of the reflector 62, the polyester resin foil 66, the adhesive material 67, or the PET material 62 is interposed, respectively, and the wave director 61 and the reflector 62 are connected by capacitive coupling. In addition, it is possible to arbitrarily set the above-mentioned angle (θ) formed by the direction of extension of the wave director 61 and the direction of extension of the reflector 62 according to the communication range, the communication directionality, etc.

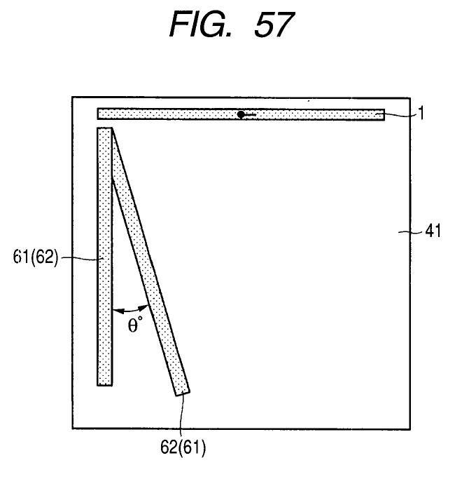

By the present third embodiment as described above also, it is possible to obtain the same effect as that in the above-mentioned first embodiment. In the present third embodiment also, the arrangement pattern of the wave director 61 and the reflector 62 on the adhesive surface of the label seal 41 may be, as shown in FIG. 57, a pattern obtained by reversing the arrangement pattern of the wave director 61 and the reflector 62 shown in the above-mentioned FIG. 56.

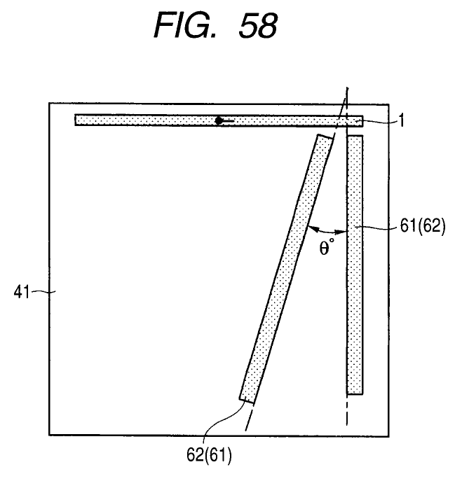

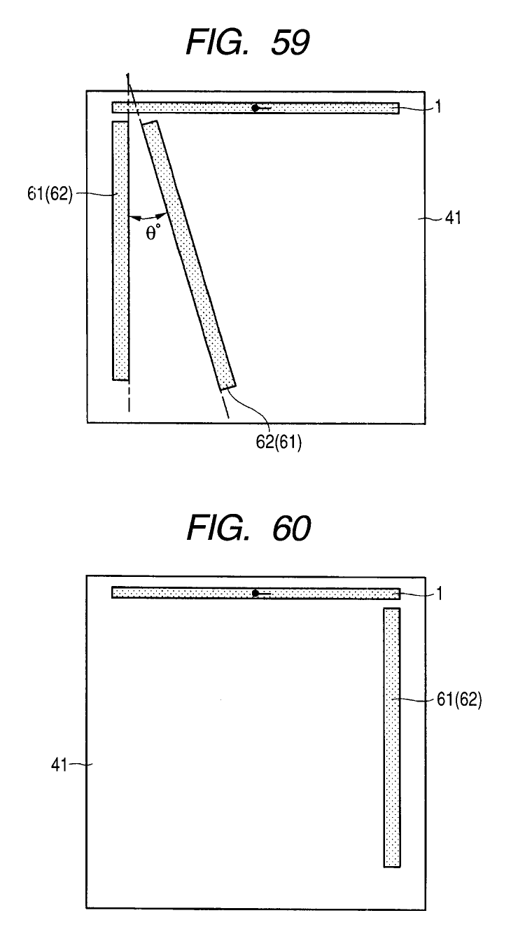

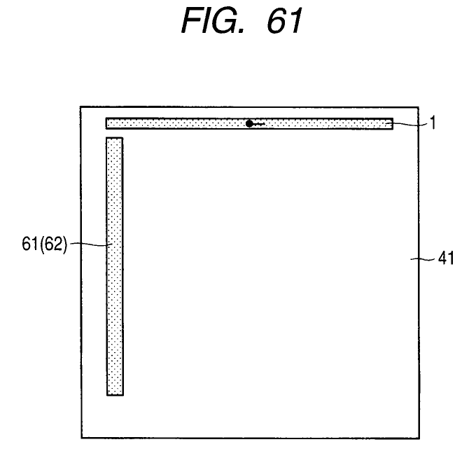

FIG. 58, FIG. 59, FIG. 60, and FIG. 61 show modification examples of the arrangement pattern of the wave director 61 and the reflector 62 on the adhesive surface of the label seal 41 in the present third embodiment. In FIG. 58 and FIG. 59, the wave director 61 and the reflector 62 are arranged on the same plane separately from each other so that the direction of extension of the wave director 61 and the direction of extension of the reflector 62 form the angle (θ) as in the third embodiment. In addition, in FIG. 60 and FIG. 61, only the reflector 61 is arranged on the adhesive surface of the label seal 41 along one side of the label seal 41 in the direction perpendicular to the direction of extension of the inlet 1 in the vicinity of the one side separately from the inlet 1. In other words, on the adhesive surface of the label seal 41, the inlet 1 and the reflector 62 are pasted in an arrangement pattern in the shape of an approximate L letter.

FIG. 58, FIG. 59, FIG. 60, and FIG. 61 are modification examples of the arrangement pattern of the wave director 61 and the reflector 62 on the adhesive surface of the label seal 41 in the third embodiment shown in FIG. 56, FIG. 57 described above, and in these cases also, it is possible to obtain the same effect as that in the above-mentioned first embodiment.

### Fourth Embodiment

Next, a fourth embodiment will be described.

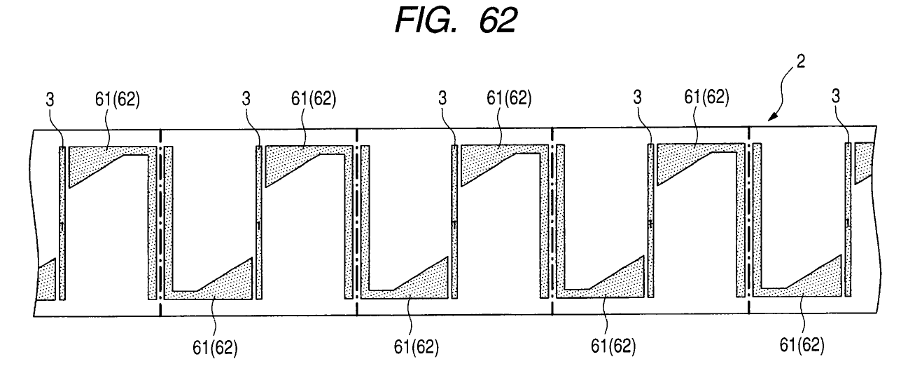

In the above-mentioned first embodiment, the case is described where a large number of antennas 3 which constitute the inlet 1 are formed in advance at predetermined intervals on one surface of the insulating film 2 in the form of a continuous tape and such an insulating film 2 is used in the manufacture of the contactless electronic tag (refer to FIG. 13 and FIG. 14). In the present fourth embodiment, as shown in FIG. 62, not only the antennas 3 but also a large number of wave directors 61 and reflectors 62 are formed at predetermined intervals on one surface of the same kind of insulating film 2 as the insulating film 2 in the above-mentioned first embodiment. In the present third embodiment, the wave director 61 and the reflector 62 can be formed integrally with the antenna 3 by etching the Al foil into the shapes of the wave director 61 and the reflector 62 when etching the Al foil to form the antenna 3. Using such an insulating film 2, by cutting the insulating film 2 along the alternate long and short dash line in FIG. 62 after bonding the chip 5 to the antenna 3 (refer to FIG. 15 to FIG. 17), it is possible to manufacture the contactless electronic tag in the present fourth embodiment. By the way, the arrangement pattern of the antenna 3, the wave director 61, and the reflector 62 shown in FIG. 62 is the same as the arrangement pattern of the inlet 1 (antenna 3), the wave director 61, and the reflector 62 shown in FIG. 31 in the above-mentioned first embodiment, however, it may also be the arrangement pattern shown in FIG. 33 to FIG. 39 in the above-mentioned first embodiment, or the arrangement pattern shown in FIG. 50 to FIG. 55 in the above-mentioned second embodiment, or in FIG. 56 to FIG. 61 in the above-mentioned third embodiment.

According to the above-mentioned present fourth embodiment, since the process for pasting the wave director 61 and the reflector 62 to the adhesive surface of the label seal 41, as in the above-mentioned first, second, and third embodiments, can be omitted, it is possible to simplify the manufacturing process of the contactless electronic tag.

In addition, according to the above-mentioned present fourth embodiment, since the insulating film 2 in the form of a continuous tape in which a large number of antennas 3, wave directors 61, and reflectors 62 are formed is conveyed into the manufacturing process of the contactless electronic tag in the state of being wound around the reel 25 (refer to FIG. 13), the manufacture of the contactless electronic tag is performed only by attaching the chip 5 to the antenna 3 continuously. Due to this, it becomes possible to easily automate the manufacture of the contactless electronic tag.

In addition, according to the above-mentioned present fourth embodiment, all of the insulating film 2, the antenna 3, the wave director 61, and the reflector 62 may serve as an inlet. Due to this, it is possible to use the entire surface of the inlet as a pasting label and the entire surface of the pasting label as an adhesive surface, and therefore, it is possible to improve the adhesion of the pasting label.

By the present fourth embodiment as described above also, it is possible to obtain the same effect as that in the above-mentioned first, second, and third embodiments.

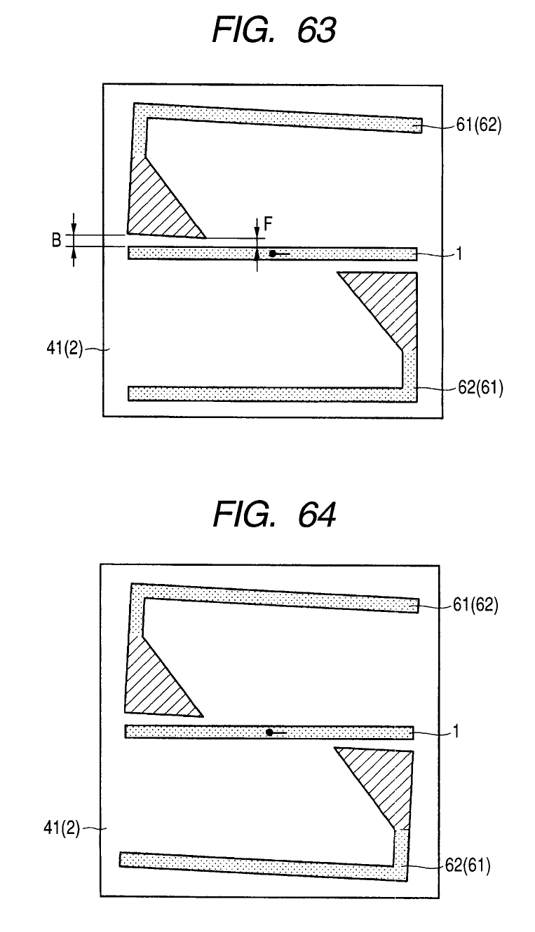

By the way, in the planar pattern in the above-mentioned first, second, third, and fourth embodiments, respectively, the wave director 61 and the reflector 62 that act as an auxiliary antenna for the inlet 1 are arranged with a gap against the inlet 1 so that its end faces the inlet and thus it becomes possible to obtain the inductor L1 and the capacitor C1 in the equivalent circuit as shown in FIG. 32. Therefore, since it becomes possible to reduce the circular polarization loss, it becomes possible to lengthen the communication range of the contactless electronic tag. In order to lengthen the communication range, it is only required for a matching circuit (resonance circuit) to be substantially formed between the inlet 1 and the wave director 61 (reflector 62) that serves as an auxiliary antenna and, for example, as shown in FIG. 63 and FIG. 64, even in the case where the pasting position is shifted in the process for pasting the wave director 61 (reflector 62) to the label seal 41, and therefore, one side of the inlet 1 and one side of the wave director 61 (reflector 62) in opposition thereto, both forming a capacitive junction, are not parallel accurately, the same effect as that in the above-mentioned first, second, third, and fourth embodiments can be obtained, because the matching circuit (resonance circuit) is formed substantially. In addition, also in the case where one side of the above-mentioned inlet 1 and one side of the above-mentioned wave director 61 (reflector 62), both forming a capacitive junction, are not accurately straight lines but including concave and convex parts, if the matching circuit (resonance circuit) is formed substantially, the same effect as that in the above-mentioned first, second, third, and fourth embodiments can be obtained.

Although the invention developed by the inventors of the present invention is described specifically as above based on the embodiments, the present invention is not limited to the above-mentioned embodiments and it is needless to say that there can be various modifications in the scope not departing from its gist.

For example, in the above-mentioned embodiments, the case where the electronic tag is manufactured using a paper label seal is described, however, it may also be possible to use a resin film label seal instead of the paper label seal.

The RFID label tag of the present invention can be used for the purposes of distribution, management, and the like of products or items, or recording of human being's entrance and leaving and recording of human being's passing.

1. An RFID label tag comprising:
an insulating tag substrate having a first main surface and a second main surface on the opposite side of the first main surface; on the first main surface of the tag substrate,
a semiconductor chip having a communication means that performs data communication by radio waves from an external communication device and a storage means that stores data;
a conductive antenna section connected to the semiconductor chip; and
a conductive auxiliary antenna section provided in close proximity to the antenna section,
wherein the auxiliary antenna section is arranged so as to be capacitively coupled to the antenna section on the same plane as that of the antenna section.

2. The RFID label tag according to claim 1,
wherein the antenna section and the auxiliary antenna section are arranged so that one side of the antenna section and one side of the auxiliary antenna section forming capacitive junction are substantially parallel to each other.

3. The RFID label tag according to claim 1,
wherein the auxiliary antenna section is arranged so as to be capacitively coupled to the antenna section via a straight line portion along one side of the antenna section.

4. The RFID label tag according to claim 1,
wherein the auxiliary antenna section is formed by any one of an aluminum foil, a compound formed by pasting the aluminum foil and a polyester resin to each other, and a PET material on which aluminum is evaporated.

5. The RFID label tag according to claim 1,
wherein the auxiliary antenna section is arranged in close proximity to the outer circumferential portion of the tag substrate.

6. The RFID label tag according to claim 1,
wherein a plurality of the auxiliary antenna sections is arranged in a point-symmetric manner with the antenna section being a symmetric point.

7. The RFID label tag according to claim 6,
wherein the antenna section and the auxiliary antenna section are arranged in the first main surface of the tag substrate in the shape of an approximate S letter or in the shape of the approximate S letter reversed front-side back.

8. The RFID label tag according to claim 1,
wherein the antenna section and the auxiliary antenna section are in the shape of an approximate L letter or in the shape of the approximate L letter reversed front-side back in the first main surface of the tag substrate.

9. The RFID label tag according to claim 1,
wherein the auxiliary antenna section is in the shape of an approximate V letter in the first main surface of the tag substrate.

10. The RFID label tag according to claim 1,
wherein the antenna section and the auxiliary antenna section are arranged in the first main surface of the tag substrate in the shape of an approximate U letter or in the shape of the approximate U letter reversed front-side back.

11. The RFID label tag according to claim 1,
wherein the auxiliary antenna section is formed by patterning a conductive film formed on the first main surface of the tag substrate.

12. The RFID label tag according to claim 1,
wherein the second main surface of the tag substrate is a label surface and the first main surface thereof is a label seal having adhesion.

13. A method for manufacturing an RFID label tag,
comprising the steps of:
(a) preparing a conductive antenna section to which a semiconductor chip having a communication means for performing data communication by radio waves from an external communication device and a storage means for storing data is connected electrically, a conductive auxiliary antenna section, and an insulating tag substrate having a first main surface and a second main surface on the opposite side of the first main surface; (b) pasting the antenna section to the first main surface of the tag substrate; and (c) bringing the auxiliary antenna section in close proximity to the antenna section to paste the auxiliary antenna section to the first main surface of the tag substrate so that the auxiliary antenna section is capacitively coupled to the antenna section.
